(19) United States
(12) Patent Application Publication
(10) Pub. No.: US 2023/0164610 A1
(43) Pub. Date: May 25, 2023

(54) CROSS LINK INTERFERENCE (CLI) MEASUREMENT ADAPTATION

(71) Applicant: QUALCOMM Incorporated, San Diego, CA (US)

(72) Inventors: Huilin XU, Temecula, CA (US); Weimin DUAN, San Diego, CA (US); Yiqing CAO, Beijing (CN)

(21) Appl. No.: 17/919,216

(22) PCT Filed: Apr. 16, 2020
(86) PCT No.: PCT/CN2020/085074

§ 371 Date: Oct. 14, 2022

(51) Int. Cl. H04W 24/10; H04B 17/336

(52) U.S. Cl. CPC H04W 24/10; H04B 17/336

(57) ABSTRACT

Aspects of the disclosure relate to wireless communication network including a user equipment (UE) performing a first set of cross link interference (CLI) measurements in accordance with a first configuration, determining whether a condition exists, and performing a second set of CLI measurements in accordance with a second configuration in response to determining that the condition exists. Other aspects relate to a wireless communication network including a base station sending a first message instructing a first user equipment (UE) to perform a first set of CLI measurements in accordance with a first configuration, processing information received from the first UE, and sending a second message to instructing the first UE to perform a second set of CLI measurements in accordance with a second configuration based on the information.

### TECHNICAL FIELD

The technology discussed below relates generally to wireless communication systems or networks, and more particularly, to a wireless communication system including a user equipment (UE) that performs cross link interference (CLI) measurements based on different conditions.

### INTRODUCTION

In many existing wireless communication systems, a cellular network is implemented by enabling wireless user equipment (UEs) to communicate with one another through signaling with a nearby base station or cell. Interference with the signaling between a base station and UE equipment (UE) may occur in such cellular networks. One type of interference occurs when a first UE transmits an uplink signal at substantially the same time as a nearby second UE receives a downlink signal. The uplink signal may interfere with the reception of the downlink signal by the second UE. This type of interference is sometimes referred to as cross link interference (CLI), or more specifically, UE-to-UE CLI.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

An example provides a user equipment (UE). The UE includes a processor, a wireless transceiver communicatively coupled to the processor, and a memory communicatively coupled to the processor. The processor and the memory are configured to perform a first set of cross link interference (CLI) measurements in accordance with a first configuration, determine whether a condition exists, and perform a second set of CLI measurements in accordance with a second configuration in response to determining that the condition exists.

Another example provides a method for wireless communication at a user equipment (UE). The method includes performing a first set of cross link interference (CLI) measurements in accordance with a first configuration, determining whether a condition exists, and performing a second set of CLI measurements in accordance with a second configuration in response to determining that the condition exists.

An example provides a user equipment (UE). The UE includes means for performing a first set of cross link interference (CLI) measurements in accordance with a first configuration, means for determining whether a condition exists, and means for performing a second set of CLI measurements in accordance with a second configuration in response to determining that the condition exists.

Another example provides a non-transitory computer-readable medium storing computer-executable code, comprising code for causing a computer in a user equipment (UE) to perform a first set of cross link interference (CLI) measurements in accordance with a first configuration, determine whether a condition exists, and perform a second set of CLI measurements in accordance with a second configuration in response to determining that the condition exists.

Another example provides a base station. The base station includes a processor, a wireless transceiver communicatively coupled to the processor, and a memory communicatively coupled to the processor. The processor and the memory are configured to send a first message instructing a first user equipment (UE) to perform a first set of CLI measurements in accordance with a first configuration using the wireless transceiver, process information received from the first UE via the wireless transceiver, and send a second message instructing the first UE to perform a second set of CLI measurements in accordance with a second configuration based on the information using the wireless transceiver.

Another example provides a method for wireless communication at a base station. The method includes sending a first message instructing a first user equipment (UE) to perform a first set of CLI measurements in accordance with a first configuration, processing information received from the first UE, and sending a second message instructing the first UE to perform a second set of CLI measurements in accordance with a second configuration based on the information.

Another example provides a base station. The base station includes means for sending a first message instructing a first user equipment (UE) to perform a first set of CLI measurements in accordance with a first configuration, means for processing information received from the first UE, and means for sending a second message instructing the first UE to perform a second set of CLI measurements in accordance with a second configuration based on the information.

Another example provides a non-transitory computer-readable medium storing computer-executable code, comprising code for causing a computer in a base station to send a first message instructing a first user equipment (UE) to perform a first set of CLI measurements in accordance with a first configuration, process information received from the first UE, and send a second message instructing the first UE to perform a second set of CLI measurements in accordance with a second configuration based on the information.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a diagram illustrating an example of a wireless radio access network according to some aspects.

FIG. 2 is a schematic diagram illustrating organization of wireless communication link resources in an air interface utilizing orthogonal frequency divisional multiplexing (OFDM) according to some aspects.

FIG. 3A illustrates an example wireless communication network with user equipment (UEs) in an intra-cell deployment according to some aspects.

FIG. 3B illustrates an example wireless communication network with user equipment (UEs) in an inter-cell, homogeneous deployment according to some aspects.

FIG. 3C illustrates an example wireless communication network with user equipment (UEs) in an inter-cell, non-co-located, heterogeneous deployment according to some aspects.

FIG. 3D illustrates an example wireless communication network with user equipment (UEs) in an inter-cell, co-located, heterogeneous deployment according to some aspects.

FIG. 4 illustrates a time-domain diagram of example slot formats of respective user equipment (UEs) according to some aspects.

FIGS. 5A-5F illustrate time-frequency domain diagrams of example different cross link interference (CLI) measurement configurations according to some aspects.

FIG. 6 illustrates a flow diagram of an example method of adapting cross link interference (CLI) measurements based on one or more conditions according to some aspects.

FIG. 7 illustrates a flow diagram of an example method of adapting cross link interference (CLI) measurements based on CLI measurements according to some aspects.

FIG. 8 illustrates a flow diagram of an example method of adapting cross link interference (CLI) measurements based on relative mobility between user equipment (UEs) according to some aspects.

FIG. 9 illustrates a flow diagram of an example method of adapting cross link interference (CLI) measurements based on distance between user equipment (UE) and a base station according to some aspects.

FIG. 10 illustrates a flow diagram of an example method of providing instruction for adapting cross link interference (CLI) measurements according to some aspects.

FIG. 11 illustrates a flow diagram of an example method of receiving instruction for adapting cross link interference (CLI) measurements according to some aspects.

FIG. 12 is a diagram illustrating an example of a hardware implementation for a user equipment (UE) processing system for cross link interference (CLI) measurements according to some aspects.

FIG. 13 is a flow diagram of an exemplary method, implemented in a user equipment (UE), for performing cross link interference (CLI) measurements according to some aspects.

FIG. 14 is a diagram illustrating an example of a hardware implementation for a base station processing system for providing instruction for adapting cross link interference (CLI) measurements according to some aspects.

FIG. 15 is a flow diagram of an exemplary method, implemented in a base station, for providing instruction for adapting cross link interference (CLI) measurements according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes and constitution.

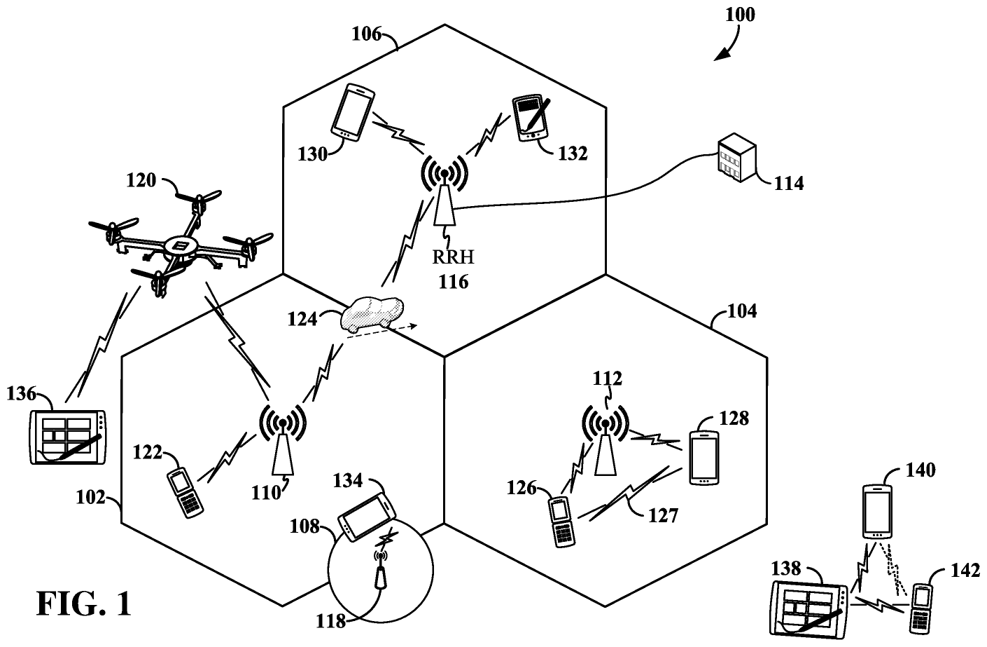

The various concepts presented throughout this disclosure may be implemented across a broad variety of telecommunication systems, network architectures, and communication standards. Referring now to FIG. 1, as an illustrative example without limitation, a schematic illustration of a radio access network 100 (e.g., a wireless communication system) is provided. The RAN 100 may implement any suitable wireless communication technology or technologies to provide radio access. As one example, the RAN 100 may operate according to 3^{rd} Generation Partnership Project (3GPP) New Radio (NR) specifications, often referred to as 5G. As another example, the RAN 100 may operate under a hybrid of 5G NR and Evolved Universal Terrestrial Radio Access Network (eUTRAN) standards, often referred to as LTE. The 3GPP refers to this hybrid RAN as a next-generation RAN, or NG-RAN. Of course, many other examples may be utilized within the scope of the present disclosure.

The geographic region covered by the radio access network 100 may be divided into a number of cellular regions (cells) that can be uniquely identified by a user equipment (UE) based on an identification broadcasted over a geographical area from one access point or base station. FIG. 1 illustrates macrocells 102, 104, and 106, and a small cell 108, each of which may include one or more sectors (not shown). A sector is a sub-area of a cell. All sectors within one cell are served by the same base station. A radio or communication link within a sector can be identified by a single logical identification belonging to that sector. In a cell that is divided into sectors, the multiple sectors within a cell can be formed by groups of antennas, with each antenna responsible for communication with UEs in a portion of the cell.

In general, a respective base station (BS) serves each cell. Broadly, a base station is a network element in a radio access network responsible for radio transmission and reception in one or more cells to or from a UE. A BS may also be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB) or some other suitable terminology.

In FIG. 1, two base stations 110 and 112 are shown in cells 102 and 104, respectively; and a third base station 114 is shown controlling a remote radio head (RRH) 116 in cell 106. That is, a base station can have an integrated antenna or can be connected to an antenna or RRH by feeder cables. In the illustrated example, the cells 102, 104, and 106 may be referred to as macrocells, as the base stations 110, 112, and 114 support cells having a large size. Further, a base station 118 is shown in the small cell 108 (e.g., a microcell, picocell, femtocell, home base station, home Node B, home eNode B, etc.), which may overlap with one or more macrocells. In this example, the cell 108 may be referred to as a small cell, as the base station 118 supports a cell having a relatively small size. Cell sizing can be done according to system design as well as component constraints. It is to be understood that the radio access network 100 may include any number of wireless base stations and cells. Further, a relay node or UE may be deployed to extend the size or coverage area of a given cell, as well as provide diversity and/or aggregated communication links between a base station and a UE. The base stations 110, 112, 114, and 118 provide wireless access points to a core network for any number of mobile apparatuses.

FIG. 1 further includes a quadcopter or drone 120, which may be configured to function as a base station. That is, in some examples, a cell may not necessarily be stationary, and the geographic area of the cell may move according to the location of a mobile base station such as the quadcopter 120.

In general, base stations may include a backhaul interface for communication with a backhaul portion (not shown) of the network. The backhaul may provide a link between a base station and a core network (not shown); and in some examples, the backhaul may provide interconnection between the respective base stations. The core network may be a part of a wireless communication system and may be independent of the radio access technology used in the radio access network. Various types of backhaul interfaces may be employed, such as a direct physical connection, a virtual network, or the like using any suitable transport network.

The RAN 100 is illustrated supporting wireless communication for multiple mobile apparatuses. A mobile apparatus is commonly referred to as a user equipment (UE) in standards and specifications promulgated by the 3rd Generation Partnership Project (3GPP), but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides a user with access to network services.

Within the present document, a “mobile” apparatus need not necessarily have a capability to move, and may be stationary. The term mobile apparatus or mobile device broadly refers to a diverse array of devices and technologies. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc.

A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device; a logistics controller; agricultural equipment; military defense equipment, vehicles, aircraft, ships, and weaponry, etc. Still further, a mobile apparatus may provide for connected medicine or telemedicine support, i.e., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Within the RAN 100, the cells may include UEs that may be in communication with one or more sectors of each cell. For example, UEs 122 and 124 may be in communication with base station 110; UEs 126 and 128 may be in communication with base station 112; UEs 130 and 132 may be in communication with base station 114 by way of RRH 116; UE 134 may be in communication with base station 118; and UE 136 may be in communication with mobile base station 120. Here, each base station 110, 112, 114, 118, and 120 may be configured to provide an access point to a core network (not shown) for all the UEs in the respective cells. In another example, a mobile network node (e.g., quadcopter 120) may be configured to function as a UE. For example, the quadcopter 120 may operate within cell 102 by communicating with base station 110.

Wireless communication between a RAN 100 and a UE (e.g., UE 122 or 124) may be described as utilizing an air interface. Transmissions over the air interface from a base station (e.g., base station 110) to one or more UEs (e.g., UE 122 and 124) may be referred to as downlink (DL) transmission. In accordance with certain aspects of the present disclosure, the term downlink may refer to a point-to-multipoint transmission originating at a scheduling entity (described further below; e.g., base station 110). Another way to describe this scheme may be to use the term broadcast channel multiplexing. Transmissions from a UE (e.g., UE 122) to a base station (e.g., base station 110) may be referred to as uplink (UL) transmission. In accordance with further aspects of the present disclosure, the term uplink may refer to a point-to-point transmission originating at a scheduled entity (described further below; e.g., UE 122).

For example, DL transmissions may include unicast or broadcast transmissions of control information and/or traffic information (e.g., user data traffic) from a base station (e.g., base station 110) to one or more UEs (e.g., UEs 122 and 124), while UL transmissions may include transmissions of control information and/or traffic information originating at a UE (e.g., UE 122). In addition, the uplink and/or downlink control information and/or traffic information may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Of course, these definitions are not required, and any suitable scheme for organizing waveforms may be utilized, and various time divisions of the waveform may have any suitable duration.

The air interface in the RAN 100 may utilize one or more multiplexing and multiple access algorithms to enable simultaneous communication of the various devices. For example, 5G NR specifications provide multiple access for UL or reverse link transmissions from UEs 122 and 124 to base station 110, and for multiplexing DL or forward link transmissions from the base station 110 to UEs 122 and 124 utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 110 to UEs 122 and 124 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Further, the air interface in the RAN 100 may utilize one or more duplexing algorithms. Duplex refers to a point-to-point communication link where both endpoints can communicate with one another in both directions. Full duplex means both endpoints can simultaneously communicate with one another. Half duplex means only one endpoint can send information to the other at a time. In a wireless link, a full duplex channel generally relies on physical isolation of a transmitter and receiver, and suitable interference cancellation technologies. Full duplex emulation is frequently implemented for wireless links by utilizing frequency division duplex (FDD) or time division duplex (TDD). In FDD, transmissions in different directions operate at different carrier frequencies. In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot.

In the RAN 100, the ability for a UE to communicate while moving, independent of their location, is referred to as mobility. The various physical channels between the UE and the RAN are generally set up, maintained, and released under the control of an access and mobility management function (AMF), which may include a security context management function (SCMF) that manages the security context for both the control plane and the user plane functionality and a security anchor function (SEAF) that performs authentication. In various aspects of the disclosure, a RAN 100 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells.

Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, UE 124 may move from the geographic area corresponding to its serving cell 102 to the geographic area corresponding to a neighbor cell 106. When the signal strength or quality from the neighbor cell 106 exceeds that of its serving cell 102 for a given amount of time, the UE 124 may transmit a reporting message to its serving base station 110 indicating this condition. In response, the UE 124 may receive a handover command, and the UE may undergo a handover to the cell 106.

In a network configured for UL-based mobility, UL reference signals from each UE may be utilized by the network to select a serving cell for each UE. In some examples, the base stations 110, 112, and 114/116 may broadcast unified synchronization signals (e.g., unified Primary Synchronization Signals (PSSs), unified Secondary Synchronization Signals (SSSs) and unified Physical Broadcast Channels (PBCH)). The UEs 122, 124, 126, 128, 130, and 132 may receive the unified synchronization signals, derive the carrier frequency and radio frame timing from the synchronization signals, and in response to deriving timing, transmit an uplink pilot or reference signal. The uplink pilot signal transmitted by a UE (e.g., UE 124) may be concurrently received by two or more cells (e.g., base stations 110 and 114/116) within the RAN 100. Each of the cells may measure a strength of the pilot signal, and the RAN (e.g., one or more of the base stations 110 and 114/116 and/or a central node within the core network) may determine a serving cell for the UE 124. As the UE 124 moves through the RAN 100, the network may continue to monitor the uplink pilot signal transmitted by the UE 124. When the signal strength or quality of the pilot signal measured by a neighboring cell exceeds that of the signal strength or quality measured by the serving cell, the RAN 100 may handover the UE 124 from the serving cell to the neighboring cell, with or without informing the UE 124.

Although the synchronization signal transmitted by the base stations 110, 112, and 114/116 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the RAN 100 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

In some examples, access to the air interface may be scheduled, wherein a scheduling entity (e.g., a base station) allocates resources (e.g., time-frequency resources) for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs or scheduled entities utilize resources allocated by the scheduling entity.

Base stations are not the only entities that may function as a scheduling entity. That is, in some examples, a UE may function as a scheduling entity, scheduling resources for one or more scheduled entities (e.g., one or more other UEs). In this example, sidelink or other type of direct link signals may be communicated directly between UEs without relying on scheduling or control information from another entity, such as a base station. For example, UE 138 is illustrated communicating with UEs 140 and 142. In some examples, the UE 138 is functioning as a scheduling entity, while UEs 140 and 142 may function as scheduled entities. For example, UE 138 may function as a scheduling entity in a device-to-device (D2D), peer-to-peer (P2P), vehicle-to-everything (V2X), and/or in a mesh network. In a mesh network example, UEs 140 and 142 may optionally communicate directly with one another in addition to communicating with the scheduling entity 138.

In other examples, two or more UEs (e.g., UEs 126 and 128) within the coverage area of a serving base station 112 may communicate with both the base station 112 using cellular signals and with each other using direct link (e.g., sidelink) signals 127 without relaying that communication through the base station. In an example of a V2X network within the coverage area of the base station 112, the base station 112 and/or one or both of the UEs 126 and 128 may function as scheduling entities to schedule sidelink communication between UEs 126 and 128.

The sidelink communication 127 between UEs 126 and 128 or between UEs 138, 140, and 142 may occur over a proximity service (ProSe) PC5 interface. ProSe communication may support different operational scenarios, such as in-coverage, out-of-coverage, and partial coverage. Out-of-coverage refers to a scenario in which UEs (e.g., UEs 138, 140 and 142) are outside the coverage are of a base station (e.g., base station 146), but each are still configured for ProSe communication. Partial coverage refers to a scenario in which a UE is outside the coverage area of a base station, while one or more other UEs in communication with the UE are in the coverage area of a base station. In-coverage refers to a scenario in which UEs (e.g., UEs 126 and 128) are in communication with a base station (e.g., base station 112) via a Uu (e.g., a cellular interface) connection to receive ProSe service authorization and provisioning information to support ProSe operation.

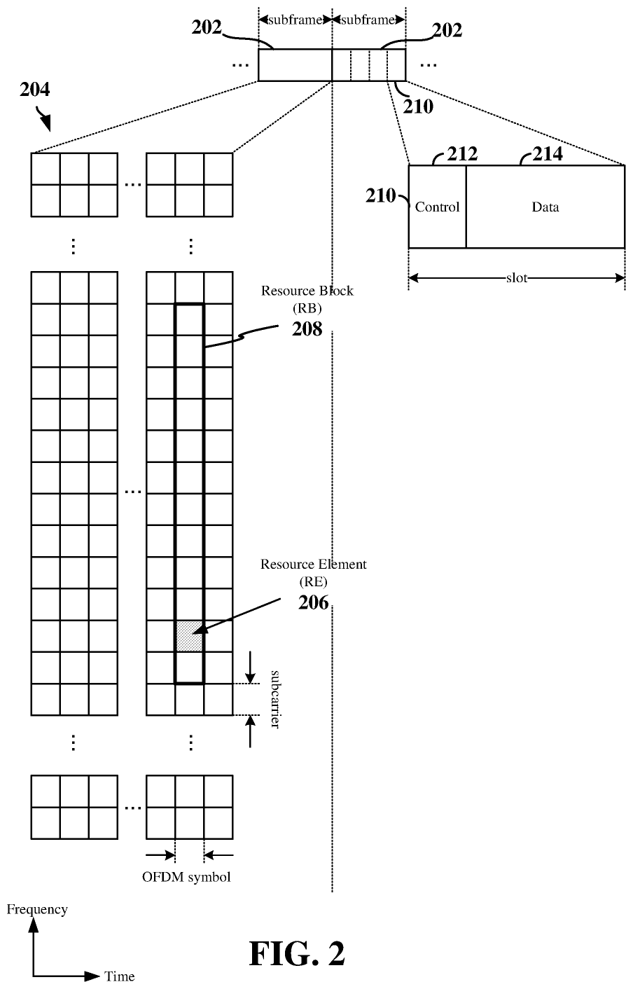

Various aspects of the present disclosure will be described with reference to an OFDM waveform, schematically illustrated in FIG. 2. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 2, an expanded view of an exemplary subframe 202 is illustrated, showing an OFDM resource grid. However, as those skilled in the art will readily appreciate, the PHY transmission structure for any particular application may vary from the example described here, depending on any number of factors. Here, time is in the horizontal direction with units of OFDM symbols; and frequency is in the vertical direction with units of subcarriers.

The resource grid 204 may be used to schematically represent time-frequency resources for a given antenna port. That is, in a multiple-input-multiple-output (MIMO) implementation with multiple antenna ports available, a corresponding multiple number of resource grids 204 may be available for communication. The resource grid 204 is divided into multiple resource elements (REs) 206. An RE, which is 1 subcarrier'1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 208, which contains any suitable number of consecutive subcarriers in the frequency domain In one example, an RB may include 12 subcarriers, a number independent of the numerology used. In some examples, depending on the numerology, an RB may include any suitable number of consecutive OFDM symbols in the time domain Within the present disclosure, it is assumed that a single RB such as the RB 208 entirely corresponds to a single direction of communication (either transmission or reception for a given device).

Scheduling of UEs devices for downlink, uplink, or sidelink transmissions typically involves scheduling one or more resource elements 206 within one or more sub-bands. Thus, a UE device generally utilizes only a subset of the resource grid 204. In some examples, an RB may be the smallest unit of resources that can be allocated to a UE device. Thus, the more RBs scheduled for a UE device, and the higher the modulation scheme chosen for the air interface, the higher the data rate for the UE device. The RBs may be scheduled by a base station (e.g., gNB, eNB, RSU, etc.) or may be self-scheduled by a UE implementing D2D sidelink communication.

In this illustration, the RB 208 is shown as occupying less than the entire bandwidth of the subframe 202, with some subcarriers illustrated above and below the RB 208. In a given implementation, the subframe 202 may have a bandwidth corresponding to any number of one or more RBs 208. Further, in this illustration, the RB 208 is shown as occupying less than the entire duration of the subframe 202, although this is merely one possible example.

Each 1 millisecond (ms) subframe 202 may consist of one or multiple adjacent slots. In the example shown in FIG. 2, one subframe 202 includes four slots 210, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots having a shorter duration (e.g., one to three OFDM symbols). These mini-slots may in some cases be transmitted occupying resources scheduled for ongoing slot transmissions for the same or for different UEs. Any number of resource blocks may be utilized within a subframe or slot.

An expanded view of one of the slots 210 illustrates the slot 210 including a control region 212 and a data region 214. In general, the control region 212 may carry control channels, and the data region 214 may carry data channels. Of course, a slot may contain all DL, all UL, or at least one DL portion and at least one UL portion. The simple structure illustrated in FIG. 2 is merely exemplary in nature, and different slot structures may be utilized, and may include one or more of each of the control region(s) and data region(s).

Although not illustrated in FIG. 2, the various REs 206 within an RB 208 may be scheduled to carry one or more physical channels, including control channels, shared channels, data channels, etc. Other REs 206 within the RB 208 may also carry pilots or reference signals, including but not limited to a demodulation reference signal (DMRS) a control reference signal (CRS), or a sounding reference signal (SRS). These pilots or reference signals may provide for a receiving device to perform channel estimation of the corresponding channel, which may enable coherent demodulation/detection of the control and/or data channels within the RB 208.

In an example of cellular communication over a cellular carrier via a Uu interface, for a DL transmission, the scheduling entity (e.g., a base station) may allocate one or more REs 206 (e.g., within the control region 212 of the slot 210) to carry DL control information including one or more DL control channels or DL signals, such as a synchronization signal block (SSB), demodulation reference signal (DMRS), channel state information-reference signal (CSI-RS), PDCCH, etc. to one or more scheduled entities (e.g., UEs). The PDCCH carries downlink control information (DCI) including, for example, scheduling information that provides a grant, and/or an assignment of REs for DL and UL transmissions.

In an UL transmission over the Uu interface, the scheduled entity may utilize one or more REs 206 to carry UL control information (UCI) including one or more UL control channels, such as a physical uplink control channel (PUCCH), to the scheduling entity. UCI may include, for example, pilots, reference signals, and information to enable or assist in decoding uplink data transmissions. For example, the UCI may include a DMRS or an SRS. In some examples, the UCI may include a scheduling request (SR), i.e., request for the scheduling entity to schedule uplink transmissions.

In addition to control information, one or more REs 206 (e.g., within the data region 214) may be allocated for user data traffic. Such traffic may be carried on one or more traffic channels, such as, for a DL transmission, a physical downlink shared channel (PDSCH); or for an UL transmission, a physical uplink shared channel (PUSCH). In some examples, one or more REs 206 may be configured to carry system information blocks (SIBs), carrying information that may enable access to a given cell.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation coding scheme (MCS) and the number of RBs in a given transmission.

The channels or carriers illustrated in FIG. 2 are not necessarily all of the channels or carriers that may be utilized between devices, and those of ordinary skill in the art will recognize that other channels or carriers may be utilized in addition to those illustrated, such as other traffic, control, and feedback channels.

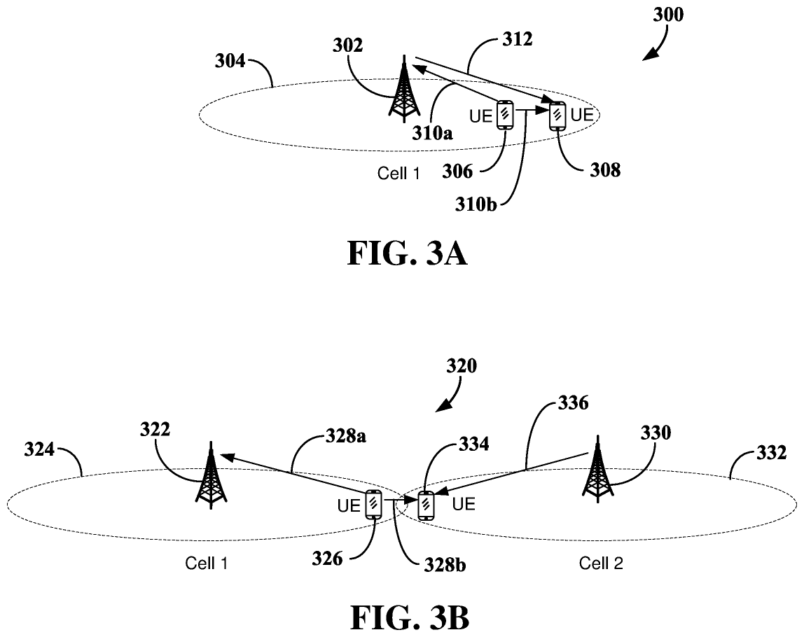

FIG. 3A illustrates an example wireless communication network 300 with user equipment (UEs) 306 and 308 in an intra-cell deployment according to some aspects. The wireless communication system network includes a base station 302 (e.g., a cellular base station (e.g., a gNB as referred to in 5G NR)) to provide wireless services to UEs, such as UEs 306 and 308, within a cell (“Cell 1”) coverage area 304. Accordingly, as illustrated, the UEs 306 and 308 are situated within the cell coverage area 304.

As illustrated, the UE 306 transmits an uplink (UL) signal 310a to the base station 302. The UE 308 also receives a downlink (DL) signal 312 from the base station 302. A portion 310b of the UL signal transmitted by the UE 306 may be received by the UE 308 while the UE 308 is receiving the DL signal 312 from the base station 302. Such portion 310b of the UL signal transmitted by the UE 306 may cause interference (e.g., in the form of noise) with the reception of the DL signal 312 by the UE 308. This type of interference is referred to as cross link interference (CLI) or, more specifically, UE-to-UE CLI. The UE 306 may be referred to as an aggressor UE (A-UE) because it is the source of the interference signal, and the UE 308 may be referred to as a victim UE (V-UE) because the interference signal affects its reception of the DL signal 312 from the base station 302.

As discussed in more detail herein, the base station 302 (or the associated network) may instruct the victim UE 308 to perform measurements of the CLI and report the measurements to the base station 302. In response, the base station 302 may take measures to mitigate the CLI, such as configure the slot format for the aggressor UE 306 and the slot format for the victim UE 308 such that UL transmission and DL reception do not collide or coincide in the time-domain or reduce the UL transmit power of the aggressor UE 306 to reduce the CLI to the victim UE 308, respectively. Other CLI mitigating measures may be taken by the base station 302.

Also, as discussed herein, a CLI measurement by the victim UE 308 may be performed by determining a received signal strength indicator (RSSI) based on the portion 310b of the UL signal transmitted by the aggressor UE 306 (e.g., estimated total energy within a particular frequency bandwidth in the UL signal 310b). Alternatively, or in addition to, a CLI measurement by the victim UE 308 may be performed by determining a reference signal receive power (RSRP) based on a reference signal, such as a sounding reference signal (SRS), in the portion 310b of the UL signal transmitted by the aggressor UE 306. There may be other techniques employed by the victim UE 308 to determine the CLI caused by the portion 310b of the UL signal transmitted by the aggressor UE 306.

FIG. 3B illustrates an example wireless communication network 320 with user equipment (UEs) 326 and 334 in an inter-cell, homogeneous deployment according to some aspects. The wireless communication network 320 includes a first base station 322 (e.g., a cellular base station (e.g., a gNB as referred to in 5G NR)) to provide wireless services to UEs, such as UE 326, within a first cell (“Cell 1”) coverage area 324. Accordingly, as illustrated, the UE 326 is situated within the cell coverage area 324. The wireless communication network 320 further includes a second base station 330 (e.g., a cellular base station (e.g., a gNB as referred to in 5G NR)) to provide wireless services to UEs, such as UE 334, within a second cell (“Cell 2”) coverage area 332. Accordingly, as illustrated, the UE 334 is situated within the cell coverage area 332.

As discussed, this configuration of the wireless communication network 320 is referred to as an inter-cell, homogeneous deployment. That is, the configuration is an inter-cell deployment because the UE 326 is being served by the first base station 322, which is different than the second base station 330 serving the UE 334. Also, the configuration is a homogeneous deployment because the cell coverage area 324 of the first base station 322 does not substantially overlap with the cell coverage area 332 of the second base station 330. In the homogeneous deployment, the cell coverage area 324 normally has similar size to the cell coverage area 332.

Similar to the wireless communication network 300 previously discussed, the UE 326 transmits an uplink (UL) signal 328a to the first base station 322. The UE 334 receives a downlink (DL) signal 336 from the second base station 330. A portion 328b of the UL signal transmitted by the UE 326 may be received by the UE 334 while the UE 334 is receiving the DL signal 336 from the second base station 330. Such portion 328b of the UL signal transmitted by the UE 326 may cause CLI with the reception of the DL signal 336 by the UE 334. Thus, the UE 326 is the aggressor UE (A-UE) and the UE 334 is the victim UE (V-UE).

As discussed in more detail herein, the second base station 330 (or the associated network) may instruct the victim UE 334 to perform measurements of the CLI and report the measurements to the second base station 330. In response, the second base station 330 may take measures to mitigate the CLI, such as configure the slot format for the aggressor UE 326 (e.g., by communicating with the first base station 322 via an X2 signaling link) and the slot format for victim UE 334 such that the UL transmission and the DL reception do not collide or coincide in the time-domain, respectively. Other CLI mitigating measures may be taken by the second base station 330.

FIG. 3C illustrates an example wireless communication network 340 with user equipment (UEs) 346 and 354 in an inter-cell, non-co-located, heterogeneous deployment according to some aspects. The wireless communication network 340 includes a first base station 342 (e.g., a cellular base station (e.g., a gNB as referred to in 5G NR)) to provide wireless services to UEs, such as UE 346, within a first cell (“Cell 1”) coverage area 344. Accordingly, as illustrated, the UE 346 is situated within the cell coverage area 344. The wireless communication network 340 further includes a second base station 350 (e.g., a cellular base station (e.g., a gNB as referred to in 5G NR)) to provide wireless services to UEs, such as UE 354, within a second cell (“Cell 2”) coverage area 352. Accordingly, as illustrated, the UE 354 is situated within the cell coverage area 352.

As discussed, this configuration of the wireless communication network 340 is referred to as an inter-cell, non-co-located, heterogeneous deployment. That is, the configuration is an inter-cell deployment because the UE 346 is being served by the first base station 342, which is different than the second base station 350 serving the UE 354. The configuration is also a heterogeneous deployment because the cell coverage area 344 of the first base station 342 overlaps with (e.g., lies entirely within) the cell coverage area 352 of the second base station 350. In the heterogeneous deployment, the cell coverage area 344 normally has different size than the cell coverage area 352. Additionally, the configuration is non-co-located, meaning that the first and second base stations 342 and 350 are not located in substantially the same location.

Similar to the wireless communication networks 300 and 320 previously discussed, the UE 346 transmits an uplink (UL) signal 348a to the first base station 342. The UE 354 receives a downlink (DL) signal 356 from the second base station 350. A portion 348b of the UL signal transmitted by the UE 346 may be received by the UE 354 while the UE 354 is receiving the DL signal 356 from the second base station 350. Such portion 348b of the UL signal transmitted by the UE 346 may cause CLI with the reception of the DL signal 356 by the UE 354. Thus, the UE 346 is the aggressor UE (A-UE) and the UE 354 is the victim UE (V-UE).

As discussed in more detail herein, the second base station 350 (or the associated network) may instruct the victim UE 354 to perform measurements of the CLI and report the measurements to the second base station 350. In response, the second base station 350 may take measures to mitigate the CLI, such as configure the slot format for the aggressor UE 346 (e.g., by communicating with the first base station 342 via a signaling link (e.g., an X2 link)) and the slot format for victim UE 354 such that the UL transmission and DL reception do not collide or coincide in the time-domain Other CLI mitigating measures may be taken by the second base station 350.

FIG. 3D illustrates an example wireless communication network 360 with user equipment (UEs) 366 and 374 in an inter-cell, co-located, heterogeneous deployment according to some aspects. The wireless communication network 360 includes a first base station 362 (e.g., a cellular base station (e.g., a gNB as referred to in 5G NR)) to provide wireless services to UEs, such as UE 366, within a first cell (“Cell 1”) coverage area 364. Accordingly, as illustrated, the UE 366 is situated within the cell coverage area 364. The wireless communication network 360 further includes a second base station 370 (e.g., a cellular base station (e.g., a gNB as referred to in 5G NR)) to provide wireless services to UEs, such as UE 374, within a second cell (“Cell 2”) coverage area 372. Accordingly, as illustrated, the UE 374 is situated within the cell coverage area 372.

As discussed, this configuration of the wireless communication network 360 is referred to as an inter-cell, co-located, heterogeneous deployment. That is, the configuration is an inter-cell deployment because the UE 366 is being served by the first base station 362, which is different than the second base station 370 serving the UE 374. The configuration is also a heterogeneous deployment because the cell coverage area 364 of the first base station 362 overlaps with (e.g., lies entirely within) the cell coverage area 372 of the second base station 370. Additionally, the configuration is co-located, meaning that the first and second base stations 362 and 370 are located in substantially the same location.

Similar to the wireless communication networks 300, 320, and 340 previously discussed, the UE 366 transmits an uplink (UL) signal 368a to the first base station 362. The UE 374 receives a downlink (DL) signal 376 from the second base station 370. A portion 368b of the UL signal transmitted by the UE 366 may be received by the UE 374 while the UE 374 is receiving the DL signal 376 from the second base station 370. Such portion 368b of the UL signal transmitted by the UE 366 may cause CLI with the reception of the DL signal 376 by the UE 374. Thus, the UE 366 is the aggressor UE (A-UE) and the UE 374 is the victim UE (V-UE).

As discussed in more detail herein, the second base station 370 (or the associated network) may instruct the victim UE 374 to perform measurements of the CLI and report the measurements to the second base station 370. In response, the second base station 370 may take measures to mitigate the CLI, such as configure the slot format for the aggressor UE 366 (e.g., by communicating with the first base station 362 via a signaling link (e.g., an X2 link)) and the slot format for victim UE 374 such that the UL transmission and the DL reception do not collide or coincide in the time-domain Other CLI mitigating measures may be taken by the second base station 370.

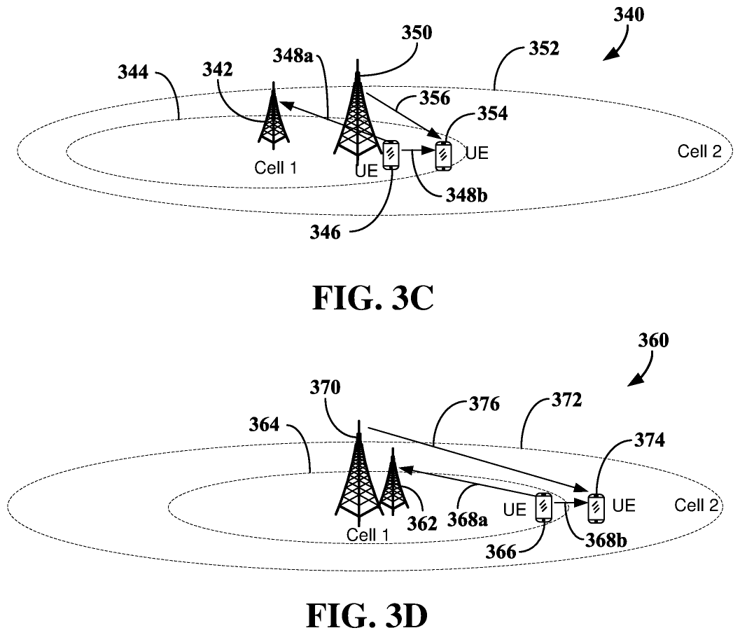

FIG. 4 illustrates a time-domain diagram of example slots of respective user equipment (UEs) according to some aspects. The horizontal axis of the time-domain diagram represents time. The upper slot pertains to a first UE1 and the lower slot pertains to a second UE2. In this example, each slot has a length of 14 OFDM symbols (numbered 1 to 14) as defined in 5G NR, but may have a length with a different number of OFDM symbols.

The UE1 has a slot format with OFDM symbols 1-6 designated for downlink (D) reception, OFDM symbols 7-8 designated as flexible (eligible for either uplink (U) transmission or downlink (D) reception), and OFDM symbols 9-14 designated for uplink (U) transmission. The UE2 has a slot format with OFDM symbols 1-10 designated for downlink (D) reception, OFDM symbols 11-12 designated as flexible (eligible for either uplink (U) transmission or downlink (D) reception), and OFDM symbols 13-14 designated for uplink (U) transmission. The OFDM symbols 1-14 pertaining to the slot of UE1 is logically time-aligned with the OFDM symbols 1-14 pertaining to the slot of UE2, respectively. However, due to different propagation delays, the physical time alignments of the slots may not be exact.

As illustrated in the diagram, the OFDM symbols 9-10 of the UE1 slot designated for uplink (U) transmission logically coincides in the time domain with the OFDM symbols 9-10 of the UE2 slot. If UE1 and UE2 are sufficiently close to each other, the uplink (U) signal transmission of UE1 during OFDM symbols 9-10 interferes with the downlink (D) signal reception of UE2 during OFDM symbols 9-10. Thus, as represented by the dashed rectangle around OFDM symbols 9-10 of the slots of UE1 and UE2, cross link interference (CLI) may occur at the receiver of UE2. As such, UE2 may not be able to receive and decode the downlink (D) signal due to the CLI. Thus, UEs are configured to monitor for CLI on a periodic or other time and frequency basis, as discussed further herein.

It shall be understood that slot formats of UE1 and UE2 may be independent of each other. That is, OFDM symbols designated for downlink in the slot format for one of the UEs need not coincide in time with OFDM symbols designated for uplink in the slot format for the other one of the UEs. Thus, when the victim UE is receiving, the aggressor UE may or may not be transmitting. The UE performs CLI measurements based on a scheduling configuration, and does not depend on the slot format of potential aggressor UEs.

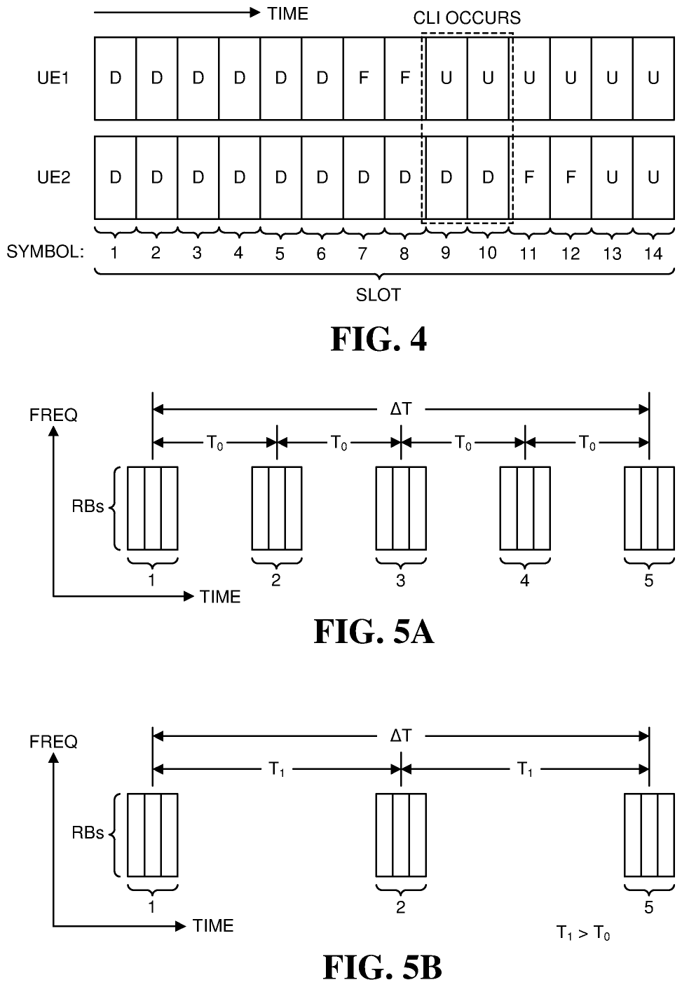

FIG. 5A illustrates a time-frequency diagram of an example set of cross link interference (CLI) measurements that a user equipment (UE) may perform in accordance with a first configuration according to some aspects. The horizontal axis of the diagram represents time. The vertical axis of the diagram represents frequency.

In accordance with the first configuration, the UE performs a set of periodic CLI measurements with a periodicity of T₀. In this example, the CLI measurements are performed over five (5) separate measurement intervals or occasions 1-5. The periodicity T₀ may be a function of the slot periodicity T_{S} (e.g., T₀=N*T_{S}, where N is an integer). Each of the CLI measurements may be performed over any number of OFDM symbols (e.g., one or more (e.g., three (3)). With regard to the frequency-domain, each of the CLI measurements may be performed over any number or fraction of RBs.

In this example, the first configuration for the set of CLI measurements may be a baseline or default configuration, or a configuration where the potential for CLI is relatively high (e.g., a non-relaxed configuration). For example, the first configuration may be one where the UE is consuming relatively high power in performing the set of CLI measurements. The accuracy of the CLI measurements in the non-relaxed configuration may be higher because of the higher number of CLI measurements. In this relatively high power consumption configuration, the periodicity T₀ is relatively small (or the frequency of the CLI measurements is relatively high), the number of OFDM symbols over which the CLI measurements is taken is relatively large, and/or the number of RBs over which the CLI measurements is taken is relatively high.

In order to conserve battery power of the UE, it may be desirable to configure the UE to perform CLI measurements in a lower power consumption configuration (e.g., a relaxed configuration). There may be certain conditions where a lower power consumption CLI measurement configuration may be warranted, such as the most recent CLI measurements indicate a low probability of CLI that would result in downlink reception issues, the CLI measurements are predictable based on the most recent CLI measurements, the UE is close to its serving base station and can ignore CLI measurements associated with UEs being served by neighboring base stations in an inter-cell, homogenous deployment, etc. The accuracy of the CLI measurements in the relaxed configuration may be lower because of the lower number of CLI measurements.

As discussed below, the lower power consumption configuration may entail increasing the periodicity of the CLI measurements, selectively skipping one or more CLI measurements in an otherwise periodic CLI measurement configuration, reduce the number of resources in the frequency-domain or the time-domain over which the CLI measurements are performed, suspending CLI measurements during a subinterval within a time duration, etc. These examples are described below in more detail. It shall be understood that there may be other techniques to perform a set of CLI measurements in a lower power consumption manner compared to the set of CLI measurements performed in accordance with the first configuration shown in FIG. 5A.

FIG. 5B illustrates a time-frequency diagram of example set of cross link interference (CLI) measurements that a user equipment (UE) may perform in accordance with a second configuration according to some aspects. The horizontal axis of the diagram represents time. The vertical axis of the diagram represents frequency.

In accordance with the second configuration, the UE performs a set of periodic CLI measurements with a periodicity of T₁. In this example, the CLI measurements are performed over three (3) separate measurement intervals or occasions 1-3; although the periodic CLI measurements may continue beyond three (3) measurement intervals or occasions. The periodicity T₁ may be a function of the slot periodicity T_{S} (e.g., T₁=N*T_{S}, where N is an integer). Each of the CLI measurements may be performed over any number of OFDM symbols (e.g., one or more (e.g., three (3)). With regard to the frequency-domain, each of the CLI measurements may be performed over any number or fraction of RBs.

In comparison with the set of CLI measurements in accordance with the first configuration depicted in FIG. 5A, the periodicity T₁ of the set of periodic CLI measurements in accordance with the second configuration is different (e.g., greater) than the periodicity T₀ of the set of periodic CLI measurements in accordance with the first configuration (e.g., T₁>T₀). In this example, the other parameters in the time-domain (e.g., number of OFDM symbols) and in the frequency domain (e.g., number of RBs) over which each of the CLI measurements are made in accordance with the second configuration may be the same as that over which each of the CLI measurements are made in accordance with the first configuration. Thus, the power consumption of the UE over a time duration ΔT in performing the CLI measurements in accordance with the second configuration is different (e.g., less) than the power consumption of the UE over the same time duration ΔT in performing the CLI measurements in accordance with the first configuration. This is because the number of CLI measurements taken over the same time duration ΔT is different (e.g., less) than in the case for the first configuration.

FIG. 5C illustrates a time-frequency diagram of example set of cross link interference (CLI) measurements that a user equipment (UE) may perform in accordance with an alternative second configuration according to some aspects. The horizontal axis of the diagram represents time. The vertical axis of the diagram represents frequency.

In accordance with this second configuration, the UE performs a set of periodic CLI measurements with a periodicity of T₀ (e.g., same as in the first configuration), but with one or more CLI measurements skipped over the time duration ΔT. In this example, the CLI measurements are performed over three (3) separate measurement intervals or occasions 1, 2, and 5, where CLI measurements over intervals or occasions 3 and 4 are skipped as represented by the shaded rectangles with Xs superimposed on them, respectively. The measurement intervals or occasions skipped may be random or pseudorandom. Similarly, each of the CLI measurements may be performed over any number of OFDM symbols (e.g., one or more (e.g., three (3)). With regard to the frequency-domain, each of the CLI measurements may be performed over any number or fraction of RBs.

In comparison with the set of CLI measurements in accordance with the first configuration depicted in FIG. 5A, the number of CLI measurements made over the time duration ΔT is three (3) in accordance with the second configuration, whereas the number of CLI measurements made over the same time duration ΔT is five (5) in accordance with the first configuration. In this example, the other parameters in the time-domain (e.g., number of OFDM symbols) and in the frequency domain (e.g., number of RBs) over which each of the CLI measurements are made in accordance with the second configuration may be the same as that over which each of the CLI measurements are made in accordance with the first configuration. Thus, the power consumption of the UE over the time duration ΔT in performing the CLI measurements in accordance with the second configuration is different (e.g., less) than the power consumption of the UE over the same time duration ΔT in performing the CLI measurements in accordance with the first configuration. This is because the number of CLI measurements taken over the same time duration ΔT is different (e.g., less) than in the case for the first configuration.

FIG. 5D illustrates a time-frequency diagram of example set of cross link interference (CLI) measurements that a user equipment (UE) may perform in accordance with another alternative second configuration according to some aspects. The horizontal axis of the diagram represents time. The vertical axis of the diagram represents frequency.

In accordance with this second configuration, the UE performs a set of periodic CLI measurements with a periodicity of T₀ (e.g., same as in the first configuration), but over a different (e.g., reduced) frequency bandwidth or different (e.g., less) number of RBs. As depicted, each of the CLI measurements is not performed over the frequency bandwidth or portion of the RBs indicated in the shaded areas with Xs superimposed, respectively; (performed over the non-shaded frequency bandwidth or portion of the RBs). With regard to the time-domain, each of the CLI measurements may be performed over any number of OFDM symbols (e.g., one or more (e.g., three (3)).

In comparison with the set of CLI measurements in accordance with the first configuration depicted in FIG. 5A, the power consumption of the UE in performing the CLI measurements in accordance with the second configuration over the time duration ΔT is different (e.g., less) than the power consumption of the UE in performing the CLI measurements in accordance with the first configuration over the time duration ΔT. This is because the UE needs not to process the signals within the excluded bandwidth or RBs in accordance with the second configuration.

FIG. 5E illustrates a time-frequency diagram of example set of cross link interference (CLI) measurements that a user equipment (UE) may perform in accordance with yet another alternative second configuration according to some aspects. The horizontal axis of the diagram represents time. The vertical axis of the diagram represents frequency.

In accordance with this second configuration, the UE performs a set of periodic CLI measurements with a periodicity of T₀ (e.g., same as in the first configuration), but over a different (e.g., reduced) time interval or number (e.g., less) of OFDM symbols. For example, each of the CLI measurements in accordance with the second configuration is performed over one (1) OFDM symbol, whereas each of the CLI measurements in accordance with the first configuration is performed over three (3) OFDM symbols. With regard to the frequency-domain, each of the CLI measurements in accordance with the second configuration may be performed over a particular bandwidth or any number of RBs (e.g., the same bandwidth or the same number of RBs as in the first configuration).

In comparison with the set of CLI measurements in accordance with the first configuration depicted in FIG. 5A, the power consumption of the UE in performing the CLI measurements in accordance with the second configuration over the time duration ΔT is different (e.g., less) than the power consumption of the UE in performing the CLI measurements in accordance with the first configuration over the same time duration ΔT. This is because the UE needs not to process the signals within the excluded OFDM symbols in accordance with the second configuration.

FIG. 5F illustrates a time-frequency diagram of example set of cross link interference (CLI) measurements that a user equipment (UE) may perform in accordance with still another alternative second configuration according to some aspects. The horizontal axis of the diagram represents time. The vertical axis of the diagram represents frequency.

In accordance with this second configuration, the UE performs a set of periodic CLI measurements with a periodicity of T₀ (e.g., same as in the first configuration), but suspends one or more of the periodic CLI measurements during a subinterval within the time duration ΔT. In this example, the CLI measurements in accordance with the second configuration are taken over measurement intervals 1-2, but thereafter, the measurements are suspended over the measurement intervals 3-5 or during the corresponding subinterval within the time duration ΔT.

As a particular example, the CLI measurements over intervals or occasions 3-5 may be suspended if the victim UE moves relatively close to its serving base station after the second CLI measurement, and the first and second CLI measurements were associated with an aggressor UE that is served by a neighboring base station in an inter-cell, homogeneous deployment. In this example, the CLI measurements for intervals or occasions 3-5 may be suspended because the aggressor UE is probably far away from the victim UE that any potential CLI is so small that it does not significantly affect the reception of the downlink signal by the victim UE.

With regard to the CLI measurements performed during the first and second measurement intervals or occasions, each of the CLI measurements in accordance with the second configuration may have been performed over the same bandwidth or over the same number of RBs as in the first configuration. Similarly, each of the CLI measurements in accordance with the second configuration may have been performed over time interval or over the same number of OFDM symbols as in the first configuration. In comparison with the set of CLI measurements in accordance with the first configuration depicted in FIG. 5A, the power consumption of the UE in performing the CLI measurements in accordance with the second configuration over the time duration ΔT is different (e.g., less) than the power consumption of the UE in performing the CLI measurements in accordance with the first configuration over the same time duration ΔT. This is because the number of CLI measurements taken over the same time duration ΔT is different (e.g., less) than in the case for the second configuration.

It shall be understood that the relatively low power consumption CLI measurement configuration may be any combination of the CLI measurement configuration discussed with reference to FIGS. 5B-5F. For example, the relatively low power consumption CLI measurement configuration may be a combination of configurations depicted in FIGS. 5B and 5D, where the periodicity T₁ is greater than the periodicity T₀ of the relatively high power consumption configuration of FIG. 5A, and the bandwidth or number of RBs over which each CLI measurement is taken in accordance with the relatively low power consumption configuration is narrower or less than the bandwidth or number of RBs over which each CLI measurement is taken in accordance with the relatively high power consumption configuration. Other combinations of the relatively low power consumption configurations of FIGS. 5B-5F are possible.

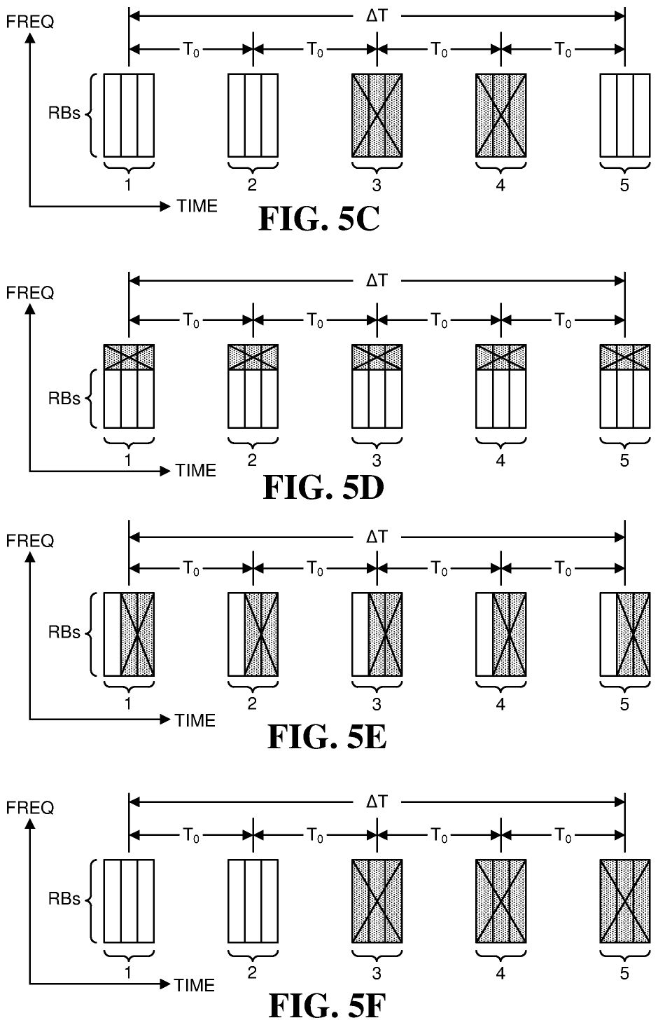

FIG. 6 illustrates a flow diagram of an example method 600 of adapting cross link interference (CLI) measurements based on a condition according to some aspects. The method 600 includes a user equipment (UE) performing one or more cross link interference (CLI) measurements in accordance with a first configuration (block 602). For example, the first configuration may be a relatively high power consumption configuration, such as the one described with reference to FIG. 5A.

The method 600 further includes the UE determining whether a condition exists (block 604). This may be a condition in which the UE may be justified in performing the CLI measurements in accordance with a relatively low power consumption configuration as compared to that of the first configuration. For example, as discussed in more detailed herein, the condition may be that one or more CLI measurements performed in accordance with the first configuration indicates that the CLI is not going to significantly impact the reception of the downlink signal from the serving base station. Or, the condition may be that one or more CLI measurements or signals received from an aggressor UE in accordance with the first configuration indicates that the CLI measurements are predictable or not changing much, as in the case where the relative mobility between the victim UE and the aggressor UE is relatively small Or, the condition may be that that the victim UE is relatively close to its serving base station, and the victim UE may exclude CLI measurements associated with aggressor UEs being served by neighboring base stations in an inter-cell, homogeneous deployment.

If, in block 606, the UE determines that the condition does not exist, the UE may continue to perform the CLI measurements in accordance with the first configuration (block 602). If, on the other hand, the UE, in block 606, determines that the condition does exist, the UE performs one or more CLI measurements in accordance with a second configuration (block 608). The second configuration may be a relatively low power consumption configuration as compared with the first configuration. That is, the second configuration may be any one of the CLI measurement configurations discussed with reference to FIGS. 5B-5F, or any combination thereof, or other type of relatively low power consumption CLI measurement configuration.

The method 600 further includes the UE determining whether the condition no longer exists or a new condition exists (block 610). This may be the case where the condition identified in block 604 no longer exists (e.g., CLI measurements in accordance with the second configuration indicate that the CLI may significantly impact the reception of the downlink signal from the serving base station, or one or more previous CLI measurements or signals received from an aggressor UE in accordance with second configuration indicates that the CLI measurements are not predictable or and changing rapidly (e.g., high relative mobility between the victim UE and the aggressor UE), or the victim UE is relatively far away from its serving base station and close to a neighboring cell where aggressor UEs uplink transmission on a different cell may cause significant CLI with the downlink reception by the victim UE). A new condition exists may be the case where the UE switched over to the lower power consumption configuration because the CLI measurements were very small, and has now detected that the relatively mobility between the UE and a potential aggressor UE is relatively high.

If, in block 612, the UE determines that the condition still exits (and no new condition exists), the UE may continue to perform the CLI measurements in accordance with the second configuration (block 608). If, on the other hand, the UE, in block 612, determines that the condition no longer exists (or a new condition exists), the UE performs one or more CLI measurements in accordance with a first configuration (block 602). Thus, if the condition is such that there is a low probability that CLI may occur at the UE, the UE may perform the CLI measurements in accordance with a relatively low power consumption configuration to save battery power. However, if the condition is such that there is a high probability that CLI may occur at the UE, the UE may perform the CLI measurements in accordance with a relatively high power consumption configuration to improve the accuracy of the measurements.

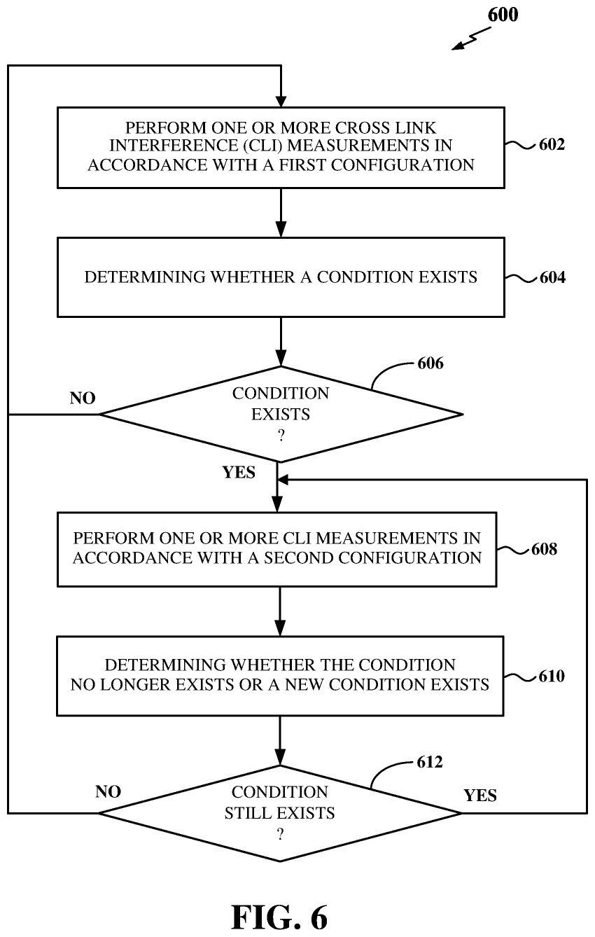

FIG. 7 illustrates a flow diagram of an example method 700 of adapting cross link interference (CLI) measurements based on a condition according to some aspects. The method 700 may be an exemplary more detailed implementation of the method 600 previously discussed. The method 700 includes a user equipment (UE) performing one or more cross link interference (CLI) measurements in accordance with a first configuration (block 702). As discussed, the first configuration may be a relatively high power consumption configuration, such as the one described with reference to FIG. 5A.

The method 700 further includes the UE determining whether the one or more CLI measurements performed in accordance with the first configuration is below a threshold for a particular duration (block 704). For example, the CLI measurements may be based on RSSI measurements from uplink signals transmitted by an aggressor UE. Accordingly, the threshold may be an RSSI threshold. Or, the CLI measurements may be based on RSRP measurements from uplink SRS transmitted by an aggressor UE. Accordingly, the threshold may be an RSRP threshold. A statistical variation of the CLI measurements may be taken to determine whether the variance is below the threshold. Or, a difference between a first (maximum) value and a second (minimum) value of the CLI measurements may be compared with the threshold to determine whether the difference is below the threshold. Or, a difference in a first detected measurement and a current detected measurement of the CLI measurements may be compared to the threshold to determine whether the difference is below the threshold. The particular duration may be zero (0); in which case, the condition may be based on a single CLI measurement being below the threshold. Or, the particular duration may span a plurality of CLI measurements; in which case, the condition may be based on a plurality of consecutive CLI measurements being below the threshold. This condition indicates that the measured CLI is relatively small that it may not impact the reception of downlink signals by the UE.

If, in block 706, the UE determines that the CLI measurements performed in accordance with the first configuration are not below the threshold for the particular duration, the UE may continue to perform the CLI measurements in accordance with the first configuration (block 702). If, on the other hand, the UE, in block 706, determines that the CLI measurements performed in accordance with the first configuration is below the threshold for the particular duration, the UE performs one or more CLI measurements in accordance with a second configuration (block 708). The second configuration may be a relatively low power consumption configuration as compared with the first configuration. That is, the second configuration may be any one of the CLI measurement configurations discussed with reference to FIGS. 5B-5F, or any combination thereof, or other type of relatively low power consumption CLI measurement configuration.

The method 700 further includes the UE determining whether CLI measurements performed in accordance with the second configuration are below a threshold for a particular duration (block 710). If, in block 712, the UE determines that the CLI measurements performed in accordance with the second configuration are below the threshold for the particular duration, the UE may continue to perform the CLI measurements in accordance with the second configuration (block 708). If, on the other hand, the UE, in block 712, determines that the CLI measurements performed in accordance with the second configuration are not below the threshold for the particular duration, the UE may revert to performing the CLI measurements in accordance with the first configuration (block 702). This condition indicates that the measured CLI is relatively high such that it may impact the reception of downlink signals by the UE. It shall be understood that the threshold and duration specified in block 704 may be the same or different (if hysteresis is desired) than the threshold and duration specified in block 710, respectively.

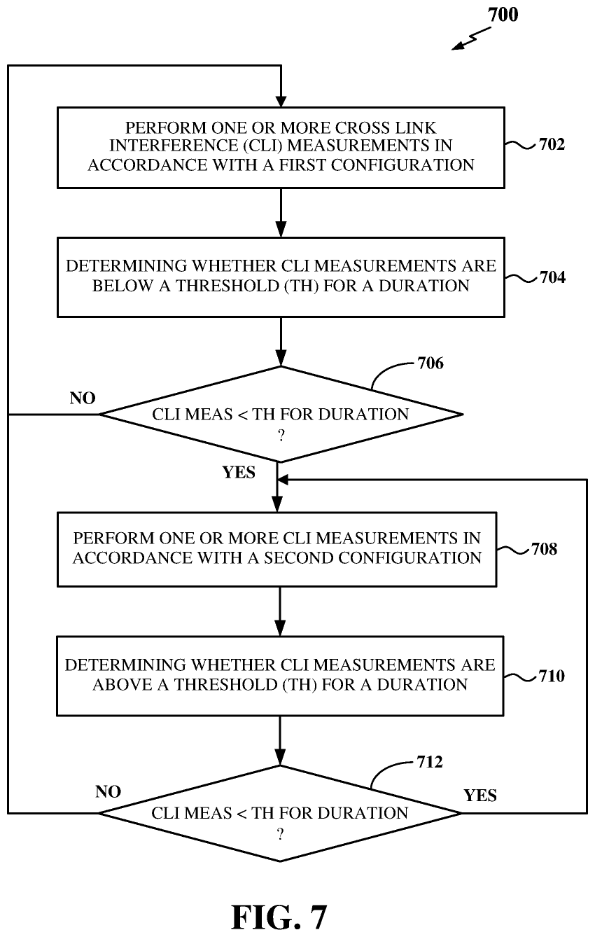

FIG. 8 illustrates a flow diagram of an example method 800 of adapting cross link interference (CLI) measurements based on a condition according to some aspects. The method 800 may be another exemplary more detailed implementation of the method 600 previously discussed. The method 800 includes a user equipment (UE) (e.g., the victim UE) performing one or more cross link interference (CLI) measurements in accordance with a first configuration (block 802). As discussed, the first configuration may be a relatively high power consumption configuration, such as the one described with reference to FIG. 5A.

The method 800 further includes the UE determining a relative mobility with respect to an aggressor UE associated with the CLI measurements in accordance with the first configuration (block 804). The relative mobility between the victim UE and the aggressor UE may be determined based on changes in the CLI measurements of the first configuration. If CLI measurements are changing significantly, it is indicative that the relative mobility between the victim UE and the aggressor UE is relatively large. If CLI measurements are not changing significantly (e.g., are substantially constant or has a small variance), it is indicative that the relative mobility between the victim UE and the aggressor UE is relatively small.

The relative mobility between the victim UE and the aggressor UE may be determined based on non-CLI measurements; for example, other measurements related to the uplink signal received from the aggressor UE. For example, the relative mobility may be determined based on changes in the time differences between consecutive uplink signals received from the aggressor UE. If the changes in the time differences are large, it is indicative that the relative mobility between the victim UE and the aggressor UE is high. If the changes in the time differences are small, it is indicative that the relative mobility between the victim UE and the aggressor UE is low.

The relative mobility may also be determined based on doppler frequency offsets of consecutive uplink signals received from the aggressor UE, respectively. If the doppler frequency offsets are large, it is indicative that the relative mobility between the victim UE and the aggressor UE is high. If the doppler frequency offsets are small, it is indicative that the relative mobility between the victim UE and the aggressor UE is low.

The relative mobility may further be determined based on changes in angle of arrival of consecutive uplink signals received from the aggressor UE. If the changes in the angle of arrival are large, it is indicative that the relative mobility between the victim UE and the aggressor UE is high. If the changes in the angle of arrival are small, it is indicative that the relative mobility between the victim UE and the aggressor UE is low. A directional antenna or antenna array in the victim UE may be used to determine the angle of arrival of the uplink signals from the aggressor UE.

The method 800 further includes determining whether the relative mobility between the victim UE and the aggressor UE is below a threshold (block 806). If, in block 806, the UE determines that the relative mobility is not below the threshold, the UE may continue to perform the CLI measurements in accordance with the first configuration (block 802). If, on the other hand, the UE, in block 806, determines that that the relative mobility is below the threshold, the UE performs one or more CLI measurements in accordance with a second configuration (block 808). The second configuration may be a relatively low power consumption configuration as compared with the first configuration. That is, the second configuration may be any one of the CLI measurement configurations discussed with reference to FIGS. 5B-5F, or any combination thereof, or other type of relatively low power consumption CLI measurement configuration.

The condition in this example is predictability. If the relative mobility between the victim UE and the aggressor UE is relatively small, then the CLI measurements are relatively predictable. Thus, there is no need to perform the CLI measurements in a relatively high power consumption configuration. If, on the other hand, the relative mobility between the victim UE and the aggressor UE is relatively large, then the CLI measurements are not relatively predictable. Thus, the CLI measurements may be performed in a relatively high power consumption configuration.

The method 800 further includes the UE continuing to determine the relative mobility between the victim UE and the aggressor UE (e.g., by CLI measurements, time differences in received signals, doppler frequency offsets in received signals, angle of arrivals of received signals, etc.) (block 810). The method 800 further includes determining whether the relative mobility between the victim UE and the aggressor UE is above a threshold (block 812). If, in block 812, the UE determines that the relative mobility is not above the threshold, the UE may continue to perform the CLI measurements in accordance with the second configuration (block 808). If, on the other hand, the UE, in block 812, determines that that the relative mobility is above the threshold, the UE performs one or more CLI measurements in accordance with the first configuration (block 802). The threshold indicated in block 806 may be the same or different (if hysteresis is desired) than the threshold indicated in block 812.

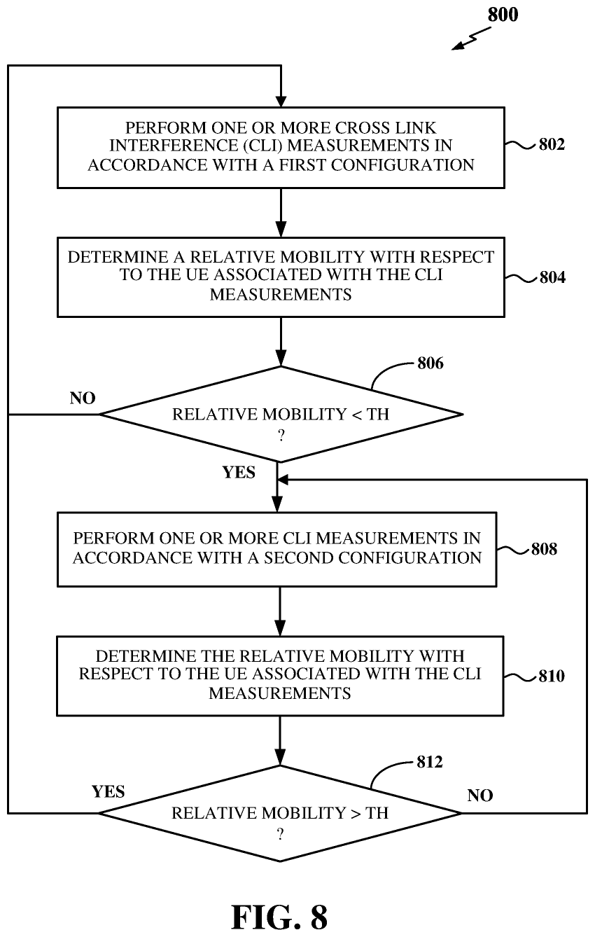

FIG. 9 illustrates a flow diagram of an example method 900 of adapting cross link interference (CLI) measurements based on a condition according to some aspects. The method 900 may be an exemplary more detailed implementation of the method 600 previously discussed. The method 900 includes a user equipment (UE) performing one or more cross link interference (CLI) measurements in accordance with a first configuration (block 902). As discussed, the first configuration may be a relatively high power consumption configuration, such as the one described with reference to FIG. 5A.

The method 900 further includes the UE determining a distance (e.g., by measuring base station signal strength or by other methods) between the UE and the serving base station (block 904). As previously discussed, if the distance between the UE and its serving base station is relatively small (e.g., the UE is around the center of the cell), the UE need not make CLI measurements associated with UEs served by neighboring base stations in other cells in an inter-cell, homogeneous deployment. This is because it is assumed that any uplink signals by aggressor UEs would not significantly interfere with the downlink signal received by the victim UE as it is close to its serving base station; and thus, the received power of the downlink signal would be relatively large and the received power of the uplink signals by aggressor UEs in other cells would be relatively small.

The method 900 further includes the UE determining whether the distance between the UE and its serving base station is below a threshold (block 906). If, in block 906, the UE determines that the distance is not below the threshold, the UE may continue to perform the CLI measurements in accordance with the first configuration (block 902). This may entail the UE considering CLI associated with UEs in neighboring cells in an inter-cell, homogeneous deployment. If, on the other hand, the UE, in block 906, determines that the distance is below the threshold, the UE performs one or more CLI measurements in accordance with a second configuration (block 908). This may entail the UE not performing CLI measurements associated with UEs in neighboring cells in an inter-cell, homogeneous deployment. The second configuration may be a relatively low power consumption configuration as compared with the first configuration because it can exclude some CLI measurements as discussed. That is, the second configuration may be any one of the CLI measurement configurations discussed with reference to FIG. 5F, where CLI measurements associated with UEs in neighboring cells are suspended.

The method 900 further includes the UE continuing to determine the distance to its serving base station (block 910). Additionally, the method 900 includes the UE determining whether the distance between the UE and its serving base station is below a threshold (block 912). If, in block 812, the UE determines that the distance is below the threshold, the UE may continue to perform the CLI measurements in accordance with the second configuration (block 908). If, on the other hand, the UE, in block 912, determines that the CLI measurements performed in accordance with the second configuration is not below the threshold, the UE may revert to performing the CLI measurements in accordance with the first configuration (block 902). It shall be understood that the threshold specified in block 906 may be the same or different (if hysteresis is desired) than the threshold specified in block 912, respectively.

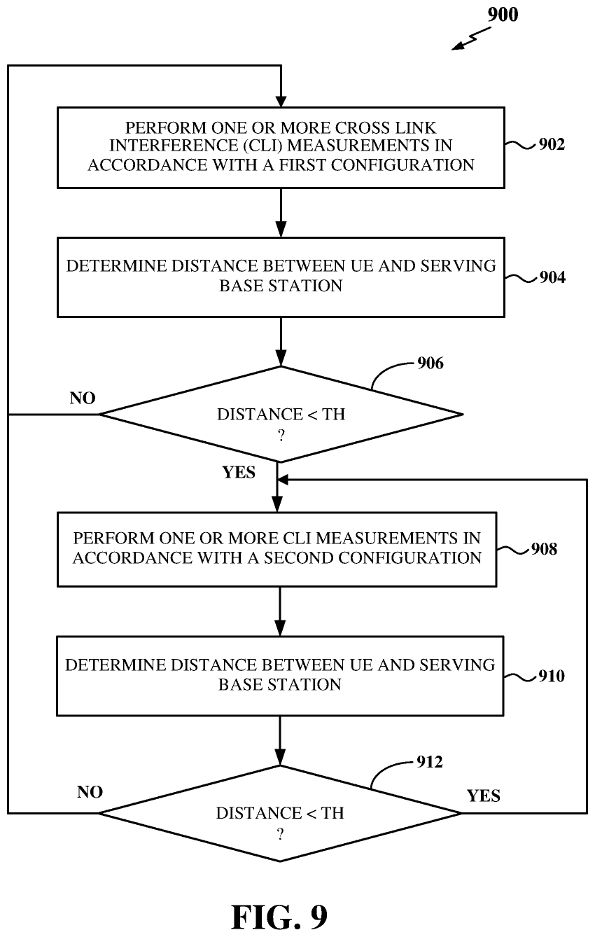

FIG. 10 illustrates a flow diagram of an example method 1000 of providing instruction for adapting cross link interference (CLI) measurements according to some aspects. As previously discussed, the determination of whether to adapt the CLI measurements based on certain conditions may be made by the victim user equipment (UE). Alternatively, such determination can also be made by the base station serving the victim UE. The method 1000 serves as an example of a base station providing instruction to a UE for adapting CLI measurements based on certain conditions as determined by the base station.

The method 1000 includes a base station sending a first message instructing a user equipment (UE) to perform a first set of CLI measurements in accordance with a first configuration (block 1002). The first configuration may be any CLI measurement configuration, such as those described with reference to FIGS. 5A-5F. The first message may include a downlink control information (DCI) message, a media access control-control element (MAC-CE) message, or a slot format indicator (SFI) message. It shall be understood that the base station may already have sent the profiles for the CLI measurement configuration to the UE, and the base station, in block 1002 (as well as in block 1006), may just inform the UE which one to perform.

The method 1000 further includes the base station processing information received from the UE (block 1004). The information may relate to or include CLI measurements performed by the UE in accordance with the first configuration. The information may further relate to the relatively mobility between the UE and an aggressor UE as measured by the UE, or the distance between the UE and the base station, etc.

The method 1000 further includes the base station sending a second message instructing the UE to perform a second set of CLI measurements in accordance with a second configuration based on the information (block 1006). The second configuration may be any CLI measurement configuration that is different than the first configuration discussed with reference to block 1002. For example, the second CLI measurement configuration may be any one of those discussed with reference to FIGS. 5A-5F. The second message may include a DCI message, MAC-CE message, or an SFI message. The first configuration may be a relatively high or low power consumption configuration, and the second configuration may be a relatively low or high power consumption configuration, respectively.

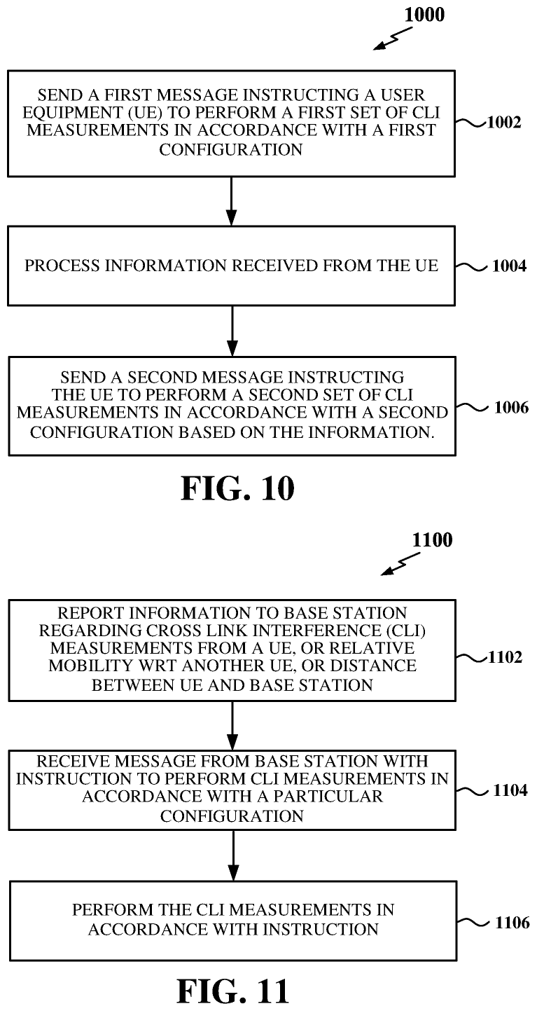

FIG. 11 illustrates a flow diagram of an example method 1100 of receiving instruction for adapting cross link interference (CLI) measurements according to some aspects. The method 1100 may be performed by a user equipment (UE), which may be complementary to the method 1000 performed by the base station, as previously discussed.

The method 1100 includes UE reporting information to a base station regarding cross link interference (CLI) measurements performed by the UE, or information regarding a relative mobility between the UE and another UE (e.g., an aggressor UE), or a distance between the UE and its serving base station (block 1102).

The method 1100 further includes the UE receiving a message from the base station with instruction to perform CLI measurements in accordance with a particular configuration (block 1104). The configuration may be any CLI measurement configuration, such as those described with reference to FIGS. 5A-5F. The message may include a DCI message, a MAC-CE message, or an SFI message. The method 1000 further includes the UE performing CLI measurements in accordance with the instruction received from the base station (block 1106).

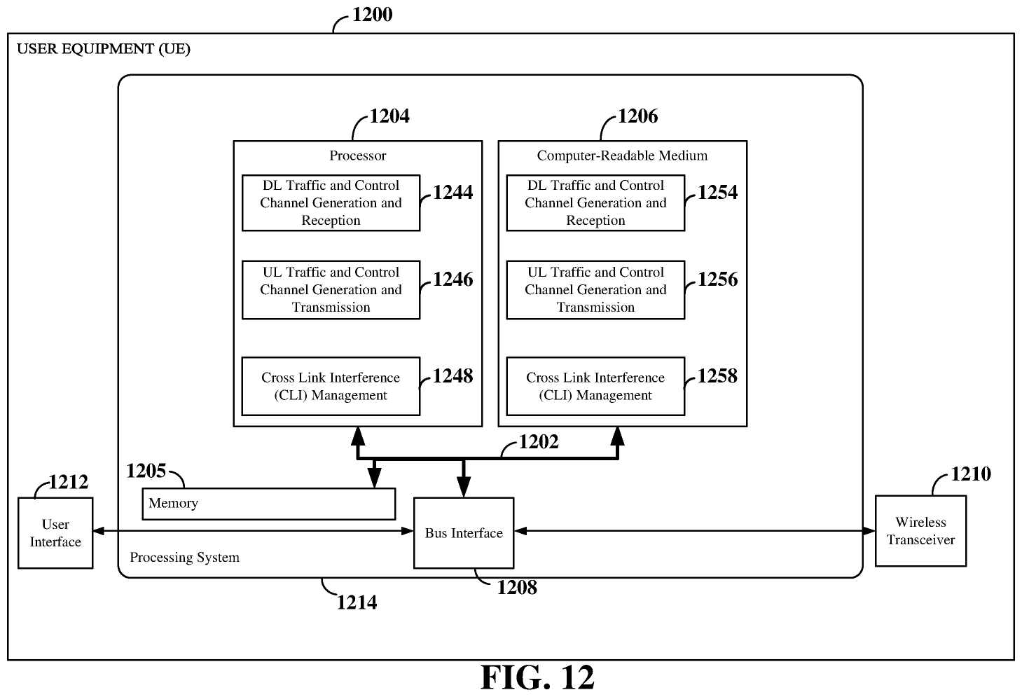

FIG. 12 is a block diagram illustrating an example of a hardware implementation for a user equipment (UE) 1200 employing a processing system 1214. For example, the UE 1200 may correspond to any of the UEs previously discussed herein.

The UE 1200 may be implemented with a processing system 1214 that includes one or more processors 1204. Examples of processors 1204 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the UE 1200 may be configured to perform any one or more of the functions described herein. That is, the processor 1204, as utilized in the UE 1200, may be used to implement any one or more of the processes and procedures described below.

In this example, the processing system 1214 may be implemented with a bus architecture, represented generally by the bus 1202. The bus 1202 may include any number of interconnecting buses and bridges depending on the specific application of the processing system 1214 and the overall design constraints. The bus 1202 links together various circuits including one or more processors (represented generally by the processor 1204), memory 1205, and computer-readable media (represented generally by the computer-readable medium 1206). The bus 1202 may also link various other circuits such as timing sources, peripherals, voltage regulators, and power management circuits, which are well known in the art, and therefore, will not be described any further.

A bus interface 1208 provides an interface between the bus 1202 and a wireless transceiver 1210. The wireless transceiver 1210 allows for the UE 1200 to communicate with various other apparatus over a transmission medium (e.g., air interface). Depending upon the nature of the apparatus, a user interface 1212 (e.g., keypad, display, touch screen, speaker, microphone, control knobs, etc.) may also be provided. Of course, such a user interface 1212 is optional, and may be omitted in some examples.

The processor 1204 is responsible for managing the bus 1202 and general processing, including the execution of software stored on the computer-readable medium 1206. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software, when executed by the processor 1204, causes the processing system 1214 to perform the various functions described below for any particular apparatus. The computer-readable medium 1206 and the memory 1205 may also be used for storing data that is manipulated by the processor 1204 when executing software.

The computer-readable medium 1206 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1206 may reside in the processing system 1214, external to the processing system 1214, or distributed across multiple entities including the processing system 1214. The computer-readable medium 1206 may be embodied in a computer program product. By way of example, a computer program product may include a computer-readable medium in packaging materials. In some examples, the computer-readable medium 1206 may be part of the memory 1205. Those skilled in the art will recognize how best to implement the described functionality presented throughout this disclosure depending on the particular application and the overall design constraints imposed on the overall system.

In some aspects of the disclosure, the processor 1204 includes DL traffic and control generation and reception circuitry 1244 for receiving information from a base station, as described herein. For example, the DL traffic and control generation and reception circuitry 1244 of a UE may be configured to receive messages from a base station to perform a set of CLI measurements in accordance with a particular configuration. The DL traffic and control channel generation and reception circuitry 1244 may further be configured to execute DL traffic and control channel generation and reception software 1254 stored in the computer-readable medium 1206 to implement one or more of the functions described herein.

The processor 1204 may further include uplink (UL) traffic and control channel generation and transmission circuitry 1246 configured to transmit information via uplink control and traffic channels to a base station. For example, the UL traffic and control channel generation and transmission circuitry 1246 of a UE may be configured to transmit information regarding CLI measurements, relative mobility between the UE and another UE, or distance between the UE and the base station. The UL traffic and control channel generation and transmission circuitry 1246 may further be configured to execute UL traffic and control channel generation and transmission software 1256 stored in the computer-readable medium 1206 to implement one or more of the functions described herein.

The processor 1204 may further include cross link interference (CLI) management circuitry 1248 configured to perform CLI measurements in accordance with a particular configuration, determine relative mobility between the UE and other UEs, determine a distance between the UE and a serving base station, etc. The CLI management circuitry 1248 may further be configured to execute CLI management software 1258 stored in the computer-readable medium 1206 to implement one or more of the functions described herein.

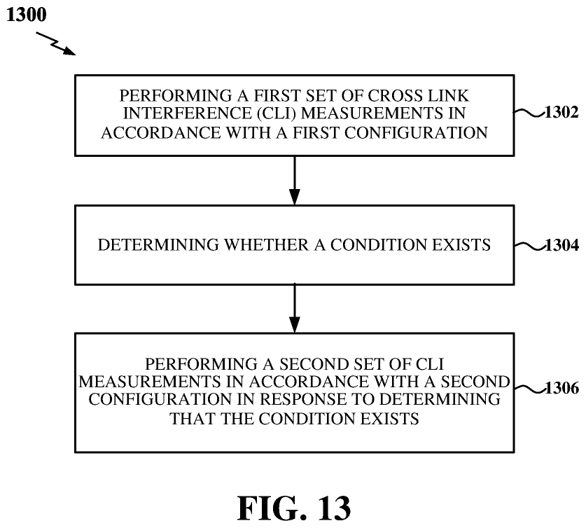

FIG. 13 is a flow diagram of an exemplary method 1300 for wireless communication at a user equipment (UE). The method 1300 includes the cross link interference (CLI) management circuitry 1248 executing the cross link interference (CLI) management software 1258 in the computer-readable medium 1206 to perform a first set of cross link interference (CLI) measurements in accordance with a first configuration (block 1302). The method 1300 further includes the CLI management circuitry 1248 executing the CLI management software 1258 in the computer-readable medium 1206 to determine whether a condition exists (block 1304). Additionally, the method 1300 includes the CLI management circuitry 1248 executing the CLI management software 1258 in the computer-readable medium 1206 to perform a second set of CLI measurements in accordance with a second configuration in response to determining that the condition exists (block 1306).

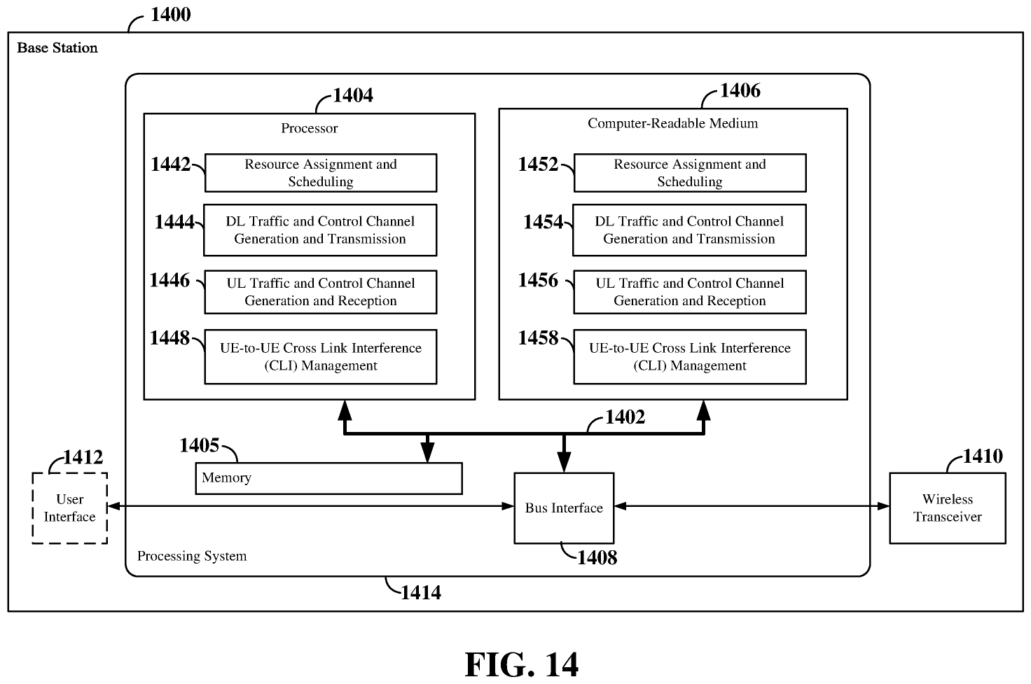

FIG. 14 is a block diagram illustrating an example of a hardware implementation for a base station 1400 employing a processing system 1414. For example, the base station 1400 may correspond to any of the base stations previously discussed herein.

The base station 1400 may be implemented with a processing system 1414 that includes one or more processors 1404. Examples of processors 1404 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the base station device 1400 may be configured to perform any one or more of the functions described herein. That is, the processor 1404, as utilized in the base station 1400, may be used to implement any one or more of the processes and procedures described below.

In this example, the processing system 1414 may be implemented with a bus architecture, represented generally by the bus 1402. The bus 1402 may include any number of interconnecting buses and bridges depending on the specific application of the processing system 1414 and the overall design constraints. The bus 1402 links together various circuits including one or more processors (represented generally by the processor 1404), a memory 1405, and computer-readable media (represented generally by the computer-readable medium 1406). The bus 1402 may also link various other circuits such as timing sources, peripherals, voltage regulators, and power management circuits, which are well known in the art, and therefore, will not be described any further.

A bus interface 1408 provides an interface between the bus 1402 and a wireless transceiver 1410. The wireless transceiver 1410 allows for the base station 1400 to communicate with various other apparatus over a transmission medium (e.g., air interface). Depending upon the nature of the apparatus, a user interface 1412 (e.g., keypad, display, touch screen, speaker, microphone, control knobs, etc.) may also be provided. Of course, such a user interface 1412 is optional, and may be omitted in some examples.

The processor 1404 is responsible for managing the bus 1402 and general processing, including the execution of software stored on the computer-readable medium 1406. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software, when executed by the processor 1404, causes the processing system 1414 to perform the various functions described below for any particular apparatus. The computer-readable medium 1406 and the memory 1405 may also be used for storing data that is manipulated by the processor 1404 when executing software.

The computer-readable medium 1406 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1406 may reside in the processing system 1414, external to the processing system 1414, or distributed across multiple entities including the processing system 1414. The computer-readable medium 1406 may be embodied in a computer program product. By way of example, a computer program product may include a computer-readable medium in packaging materials. In some examples, the computer-readable medium 1406 may be part of the memory 1405. Those skilled in the art will recognize how best to implement the described functionality presented throughout this disclosure depending on the particular application and the overall design constraints imposed on the overall system.

In some aspects of the disclosure, the processor 1404 may include circuitry configured for various functions. For example, the processor 1404 may include resource assignment and scheduling circuitry 1442 configured to assign and schedule resources for downlink and uplink transmissions with one or more UEs via one or more cellular communication links, respectively. For example, the resource assignment and scheduling circuitry 1442 of a base station is configured to assign and schedule resources for uplink and downlink communication links to transmit and receive CLI related information to and from UEs, as discussed herein. The resource assignment and scheduling circuitry 1442 may be configured to execute resource assignment and scheduling software 1452 stored in the computer-readable medium 1406 to implement one or more of the functions described herein.

The processor 1404 further includes a DL traffic and control channel generation and transmission circuitry 1444 for transmitting DL data to one or more UEs, as described herein. For example, the DL traffic and control channel generation and transmission circuitry 1444 of a base station may be configured to send messages instructing UEs to perform CLI measurements in accordance with a particular configuration. The DL traffic and control channel generation and transmission circuitry 1444 may further be configured to execute DL traffic and control channel generation and transmission software 1454 stored in the computer-readable medium 1406 to implement one or more of the functions described herein.

The processor 1404 may further include uplink (UL) traffic and control channel generation and reception circuitry 1446 configured to receive and process data sent via uplink control channels and uplink traffic channels from one or more UEs. For example, the UL traffic and control channel generation and reception circuitry 1446 of a base station may be configured to receive CLI related information from UEs, as described herein. The UL traffic and control channel generation and reception circuitry 1446 may further be configured to execute UL traffic and control channel generation and reception software 1456 stored in the computer-readable medium 1406 to implement one or more of the functions described herein.

The processor 1404 may further include UE-to-UE cross link interference (CLI) management circuitry 1448 configured to process information related to CLI measurements performed by UEs and provide CLI measurement instructions to UEs, as described herein. The UE-to-UE CLI management circuitry 1448 may further be configured to execute UE-to-UE CLI management software 1458 stored in the computer-readable medium 1406 to implement one or more of the functions described herein.

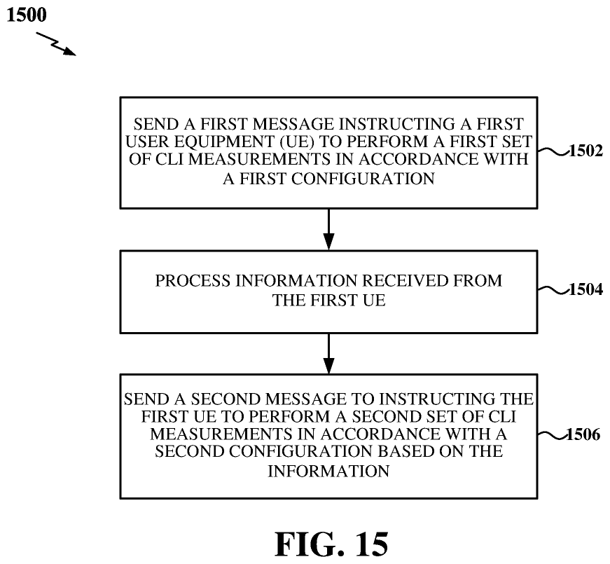

FIG. 15 is a flow chart of a method 1500 for wireless communication at a base station. The method 1500 includes the DL traffic and control channel generation and transmission circuitry 1444 executing the DL traffic and control channel generation and transmission software 1454 in the computer-readable medium 1406 to send a first message instructing a first user equipment (UE) to perform a first set of CLI measurements in accordance with a first configuration using the wireless transceiver 1410 (block 1502). The method 1500 further includes the UL traffic and control channel generation and reception circuitry 1446 executing the UL traffic and control channel generation and reception software 1456 and the UE-to-UE cross link interference (CLI) management circuitry 1448 executing the UE-to-UE cross link interference (CLI) management software 1458 to process information received from the first UE via the wireless transceiver 1410 (block 1504). Additionally, the method 1500 includes DL traffic and control channel generation and transmission circuitry 1444 executing the DL traffic and control channel generation and transmission software 1454 in the computer-readable medium 1406 to send a second message instructing the first UE to perform a second set of CLI measurements in accordance with a second configuration based on the information using the wireless transceiver 1410 (block 1506).

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-15 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1, 3A-3D, 12, and 14 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1-96. (canceled)

97. A user equipment (UE), comprising:
a wireless transceiver;
a memory; and
a processor communicatively coupled with the wireless transceiver and the memory, the processor configured to cause the UE to:
perform a first set of cross link interference (CLI) measurements on first uplink signals transmitted by a second UE in accordance with a first inter-cell configuration associated with service by a serving base station; and
perform a second set of CLI measurements on second uplink signals transmitted by the second UE in accordance with a second inter-cell configuration associated with the service by the serving base station based on an impact uplink transmissions by the second UE are expected to have on downlink reception by the UE.

98. The UE of claim 97, wherein the first set of CLI measurements comprises a first set of periodic CLI measurements with a first periodicity, wherein the second set of CLI measurements comprises a second set of periodic CLI measurements with a second periodicity, and wherein the second periodicity is different than the first periodicity.

99. The UE of claim 97, wherein a number of CLI measurements in the first set of CLI measurements over a time duration is different than a number of CLI measurements in the second set of CLI measurements over the time duration.

100. The UE of claim 97, wherein:
the first set of CLI measurements comprises a first set of periodic CLI measurements with a periodicity over a time duration, and
the second set of CLI measurements comprises:
a second set of periodic CLI measurements with the periodicity but with one or more CLI measurements of the second set of periodic CLI measurements skipped during the time duration; or
a second set of periodic CLI measurements with the periodicity but with one or more CLI measurements of the second set periodic CLI measurements suspended during a subinterval within the time duration.

101. The UE of claim 97, wherein:
each of the first set of CLI measurements is performed over a first frequency bandwidth, wherein each of the second set of CLI measurements is performed over a second frequency bandwidth, and wherein the second frequency bandwidth is different than the first frequency bandwidth;
each of the first set of CLI measurements is performed over a first set of one or more resource blocks (RBs), and wherein each of the second set of CLI measurements is performed over a second set of one or more RBs, wherein a number of one or more RBs in the first set is different than a number of one or more RBs in the second set;
each of the first set of CLI measurements is performed over a first time interval, wherein each of the second set of CLI measurements is performed over a second time interval, and wherein the second time interval is different than the first time interval; or
each of the first set of CLI measurements is performed over a first set of one or more orthogonal frequency division multiplexing (OFDM) symbols, wherein each of the second set of CLI measurements is performed over a second set of one or more OFDM symbols, and wherein a number of one or more OFDM symbols in the first set is different than a number of one or more OFDM symbols in the second set.

102. The UE of claim 97, wherein a first power consumption associated with performing the first set of CLI measurements over a time duration is different than a second power consumption associated with performing the second set of CLI measurements over the time duration.

103. The UE of claim 97, further comprising determining the impact based on at least one of:
one or more CLI measurements of the first set of CLI measurements being below or above a threshold;
a plurality of the CLI measurements of the first set of CLI measurements being below or above a threshold over a time duration;
a relative mobility between the UE and the second UE being below or above a threshold; or
a distance to, or strength of a signal received from, the serving base station being above or below a threshold.

104. The UE of claim 103, wherein the processor is configured to determine the relative mobility based on at least one of:
a plurality of the CLI measurements of the first set of CLI measurements;
a difference between a value of a first CLI measurement of the first set of CLI measurements and a value of a second CLI measurement of the first set of CLI measurements;
a statistical variation across the CLI measurements of the first set of CLI measurements;
a difference between a first detected CLI measurement of the first set of CLI measurements associated with the second UE and a second detected CLI measurement of the first set of CLI measurements associated with the second UE;
doppler frequency offsets associated with received signals from the second UE;
a time difference between receiving signals from the second UE; or
angles of arrival of signals received from the second UE.

105. The UE of claim 97, wherein the processor is further configured to:
transmit a report that indicates the first set of CLI measurements to the serving base station using the wireless transceiver;
receive a message from the serving base station using the wireless transceiver, wherein the message indicates the impact uplink transmissions by the second UE are expected to have on downlink reception by the UE; and
perform the second set of CLI measurements in response to the message.

106. A method for wireless communication at a user equipment (UE), the method comprising:
performing a first set of cross link interference (CLI) measurements on first uplink signals transmitted by a second UE in accordance with a first inter-cell configuration associated with service by a serving base station; and
performing a second set of CLI measurements on second uplink signals transmitted by the second UE in accordance with a second inter-cell configuration associated with the service by the serving base station based on an impact the uplink transmissions by the second UE are expected to have on downlink reception by the UE.

107. The method of claim 106, wherein performing the first set of CLI measurements comprises performing a first set of periodic CLI measurements with a first periodicity, wherein performing the second set of CLI measurements comprises performing a second set of periodic CLI measurements with a second periodicity, wherein the second periodicity is different than the first periodicity.

108. The method of claim 106, wherein a number of CLI measurements in the first set of CLI measurements over a time duration is different than a number of CLI measurements in the second set of CLI measurements over the time duration.

109. The method of claim 106, further comprising receiving a message from the serving base station providing instruction to perform the second set of CLI measurements in accordance with the second configuration.

110. The method of claim 109, wherein the message comprises a downlink control information (DCI) message, a media access control-control element (MAC-CE) message, or a slot format indicator (SFI) message.

111. A base station, comprising:
a wireless transceiver; and
a memory;
a processor communicatively coupled with the wireless transceiver and the memory, the processor configured to cause the base station to:
transmit, to a first user equipment (UE) using the wireless transceiver, a first message instructing the first UE to perform a first set of CLI measurements on first uplink signals transmitted by a second UE in accordance with a first inter-cell configuration;
receive, from the first UE using the wireless transceiver, a report that indicates the first set of CLI measurements; and
transmit, to the first UE using the wireless transceiver, a second message instructing the first UE to perform a second set of CLI measurements on second uplink signals transmitted by a second UE in accordance with a second inter-cell configuration based on an impact uplink transmissions by the second UE are expected to have on downlink reception by the first UE.

112. The base station of claim 111, wherein the first set of CLI measurements comprises a first set of periodic CLI measurements with a first periodicity, wherein the second set of CLI measurements comprises a second set of periodic CLI measurements with a second periodicity, and wherein the second periodicity is different than the first periodicity.

113. The base station of claim 111, wherein a number of CLI measurements in the first set of CLI measurements over a time duration is different than a number of CLI measurements in the second set of CLI measurements over the time duration.

114. The base station of claim 111, wherein the first set of CLI measurements comprises a first set of periodic CLI measurements with a periodicity over a time duration, and wherein the second set of CLI measurements comprises a second set of periodic CLI measurements with the periodicity but with one or more of the periodic CLI measurements skipped over the time duration.

115. The base station of claim 111, wherein the first set of CLI measurements comprises a first set of periodic CLI measurements with a periodicity over a time duration, and wherein the second set of CLI measurements comprises a second set of periodic CLI measurements with the periodicity but with one or more of the periodic CLI measurements suspended during a subinterval within the time duration.

116. The base station of claim 111, wherein:
each of the first set of CLI measurements is performed over a first frequency bandwidth, wherein each of the second set of CLI measurements is performed over a second frequency bandwidth, and wherein the second frequency bandwidth is different than the first frequency bandwidth;
each of the first set of CLI measurements is performed over a first set of one or more resource blocks (RBs), wherein each of the second set of CLI measurements is performed over a second set of one or more RBs, and wherein a number of one or more RBs in the first set is different than a number of one or more RBs in the second set;
each of the first set of CLI measurements is performed over a first time interval, wherein each of the second set of CLI measurements is performed over a second time interval, and wherein the second time interval is different than the first time interval; or
each of the first set of CLI measurements is performed over a first set of one or more orthogonal frequency division multiplexing (OFDM) symbols, wherein each of the second set of CLI measurements is performed over a second set of one or more OFDM symbols, and wherein a number of one or more OFDM symbols in the first set is different than a number of one or more OFDM symbols in the second set.

117. The base station of claim 111, wherein the second set of CLI measurements excludes CLI measurements associated with any user equipment served by a second base station in an inter-cell, homogeneous deployment.

118. The base station of claim 111, wherein a first power consumption of the first UE associated with performing the first set of CLI measurements over a time duration is different than a second power consumption of the first UE associated with performing the second set of CLI measurements over the time duration.

119. The base station of claim 111, wherein the first or second message comprises a downlink control information (DCI) message, a media access control-control element (MAC-CE) message, or a slot format indicator (SFI) message.

120. The base station of claim 111, wherein the information is related to:
one or more CLI measurements of the first set of CLI measurements being below or above a threshold; or
a plurality of the CLI measurements of the first set of CLI measurements being below or above a threshold over a time duration.

121. The base station of claim 111, wherein the information is based on at least one of:
a relative mobility between the first UE and a second UE;
the relative mobility being above or below a threshold; or
a plurality of the CLI measurements of the first set, and wherein the processor is configured to determine the relative mobility between the first UE and a second UE based on the plurality of the CLI measurements of the first set of CLI measurements.

122. The base station of claim 121, wherein the processor is configured to determine the relative mobility based on:
a difference between a value of a first CLI measurement of the first set of CLI measurements and a second value of a second CLI measurement of the first set of CLI measurements;
a statistical variation of the CLI measurements of the first set of CLI measurements;
a difference between a first detected CLI measurement of the first set of CLI measurements associated with the second UE and a second detected CLI measurement of the first set of CLI measurements associated with the second UE; or
a distance between the first UE and the base station.

123. A method for wireless communication at a base station, the method comprising:
transmitting, to a first user equipment (UE), a first message instructing the first UE to perform a first set of CLI measurements on first uplink signals transmitted by a second UE in accordance with a first inter-cell configuration;
receiving, from the first UE, a report that indicates the first set of CLI measurements; and
transmitting, to the first UE, a second message instructing the first UE to perform a second set of CLI measurements on second uplink signals transmitted by a second UE in accordance with a second inter-cell configuration based on an impact uplink transmissions by the second UE are expected to have on downlink reception by the first UE.

124. The method of claim 123, wherein the second set of CLI measurements excludes CLI measurements associated with any user equipment served by a second base station in an inter-cell, homogeneous deployment.

125. The method of claim 123, wherein the first or second message comprises a downlink control information (DCI) message, a media access control-control element (MAC-CE) message, or a slot format indicator (SFI) message.
